(19) United States
(12) Patent Application Publication
(10) Pub. No.: US 2017/0004485 A1
(43) Pub. Date: Jan. 5, 2017

(54) METHOD FOR PAYMENT USING SHORT RANGE COMMUNICATION AND ELECTRONIC DEVICE THEREFOR

(71) Applicant: Samsung Electronics Co., Ltd., Suwon-si (KR)

(72) Inventors: Chang-Ho LEE, Suwon-si (KR); Geon-Soo KIM, Suwon-si (KR); Won-Kyu KWON, Seoul (KR); Se Chang SOHN, Suwon-si (KR); Jun-Yong SIM, Suwon-si (KR); Sung-Jae LIM, Seoul (KR)

(21) Appl. No.: 15/196,810

(22) Filed: Jun. 29, 2016

(30) Foreign Application Priority Data
Jul. 2, 2015 (KR) 10-2015-0094697

(51) Int. Cl. G06Q 20/32; G06Q 20/34; G06K 7/10

(52) U.S. Cl. CPC G06Q 20/327; G06K 7/10356; G06Q 20/34; G06Q 20/3226

(57) ABSTRACT

An apparatus and a method for payment using short range communication are disclosed. The apparatus includes an electronic device having a communication module configured to wirelessly transmit at least one piece card information to an external device, a sensor configured to sense an orientation of the electronic device so as to generate a first signal, a processor configured to be electrically connected the wireless communication module and the sensor, and a memory configured to be electrically connected to the processor and at least temporarily store first card information and second card information, wherein the memory, at the time of execution, includes instructions which instruct the processor to receive the first signal, select one of the first card information and the second card information, at least partially on the basis of the first signal, and wirelessly transmit the selected card information to the external device.

### CROSS-REFERENCE TO RELATED APPLICATION(S)

This application claims the benefit under 35 U.S.C. §119(a) of a Korean patent application filed on Jul. 2, 2015 in the Korean Intellectual Property Office and assigned Serial number 10-2015-0094697, the entire disclosure of which is hereby incorporated by reference.

### TECHNICAL FIELD

The present disclosure relates to payment using a short range communication in an electronic device.

### BACKGROUND

Recently, as portable electronic devices such as smart phones have become widely spread, the electronic devices have provided various functions for user convenience. For example, a user can perform payment using such an electronic device. In other words, the electronic device may provide a payment process, which is performed by reading a physical card through a card reader, using a short range communication technology (e.g. near field communication (NFC)).

The above information is presented as background information only to assist with an understanding of the present disclosure. No determination has been made, and no assertion is made, as to whether any of the above might be applicable as prior art with regard to the present disclosure.

### SUMMARY

For making a payment using an electronic device, the electronic device may store payment-related data e.g. card information or payment method). The payment may be performed by reading the card information, using a reader (e.g. point of sale (POS)) having a short range communication technology. Generally, the electronic device may have payment-related data of a default value. Therefore, when a user desires to change a card used to make payment at the time of payment using a short range communication, the user should execute a related application and reselect a card.

Aspects of the present disclosure are to address at least the above-mentioned problems and/or disadvantages and to provide at least the advantages described below. Accordingly, an aspect of the present disclosure is to provide a device and method for performing payment in an electronic device.

Another aspect of the present disclosure is to provide a device and method for performing payment using short range communication in an electronic device.

Another aspect of the present disclosure is to provide a device and method for changing a target card at the time of payment in an electronic device.

Another aspect of the present disclosure is to provide a device and method for changing a payment method at the time of payment in an electronic device.

Another aspect of the present disclosure is to provide a device and method for changing a target card or a payment method on the basis of a state of an electronic device at the time of payment in the electronic device.

Another aspect of the present disclosure is to provide a device and method for changing a target card or a payment method on the basis of the angle of an electronic device at the time of payment in the electronic device.

Another aspect of the present disclosure is to provide a device and method for changing a target card or a payment method on the basis of the intensity of a signal at the time of payment in an electronic device.

Another aspect of the present disclosure is to provide a device and method for setting a corresponding relationship between a state of an electronic device and a card to be used for payment in the electronic device. Another aspect of the present disclosure is to provide an electronic device comprising a processor configured to select information on payment on the basis of a state of the electronic device, and a communication module configured to transmit the information to an external device, wherein the state of the electronic device comprises at least one of an orientation of the electronic device, an angle with respect to a reference axis, and an antenna used to communicate with the external device.

In accordance with an aspect of the present disclosure, an electronic device is provided. The electronic device may include a communication module that can wirelessly transmit information on at least one card to an external device, a sensor that senses an orientation of the electronic device and generates a first signal, a processor that is electrically connected to the wireless communication module and the sensor, and a memory that is electrically connected to the processor and at least temporarily stores one of first card information and second card information. The memory, at the time of execution, may store instructions which instruct the processor to receive the first signal, select one of the first card information and the second card information, at least partially on the basis of the first signal, and wirelessly transmit the selected card information to the external device.

In accordance with another aspect of the present disclosure, an electronic device is provided. The electronic device includes a housing, a communication module that is disposed inside the housing and can wirelessly transmit information on at least one card to an external device, a sensor that senses an angle which one axis of the electronic device has with respect to an external reference axis and generates a signal, a processor that is electrically connected to the wireless communication module and the sensor, and a memory that is electrically connected to the processor and at least temporarily stores first card information and second card information. The memory (at the time of execution) may store instructions which instruct the processor to connect a case where the angle is a first angle with the first card information, connect a case where the angle is a second angle with the second card information, select the first card information when the signal corresponds to the first angle, select the second card information when the signal corresponds to the second angle, and wirelessly transmit the selected card information to the external device.

In accordance with another aspect of the present disclosure, a method of making payment is provided. The method may include selecting information on payment on a basis of a state of an electronic device and transmitting the selected information to an external device, wherein the state of the electronic device comprises at least one of an orientation of the electronic device, an angle with respect to a reference axis, and one or more antennas used to communicate with the external device.

Various embodiments can change information on payment according to a state of an electronic device without the execution of an application at the time of payment using a short range communication in the electronic device, thereby dynamically changing a card used for payment.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to various embodiments of the present disclosure;

FIG. 2 is a block diagram of an electronic device according to various embodiments of the present disclosure;

FIG. 3 is a block diagram of a program module according to various embodiments of the present disclosure;

FIG. 4 illustrates a configuration of an electronic device according to various embodiments of the present disclosure;

FIG. 5 illustrates a signal exchange between an electronic device and a payment device at the time of payment using the electronic device according to various embodiments of the present disclosure;

FIG. 6 is a flowchart illustrating selecting, depending on the direction of an electronic device, a payment means and performing payment according to various embodiments of the present disclosure;

FIGS. 7A and 7B illustrate changing a payment means depending on a change of the direction of an electronic device according to various embodiments of the present disclosure;

FIG. 8 is a flowchart illustrating selecting, depending on the direction of an electronic device, a payment method and performing payment according to various embodiments of the present disclosure;

FIGS. 9A and 9B illustrate changing a payment method depending on a change of the direction of an electronic device according to various embodiments of the present disclosure;

FIG. 10 is a flowchart illustrating setting payment information depending on the angle of an electronic device according to various embodiments of the present disclosure;

FIG. 11 is a flowchart illustrating selecting a payment means depending on the angle of an electronic device according to various embodiments of the present disclosure;

FIGS. 12A to 12C illustrate a method for changing a payment means depending on the angle of an electronic device according to various embodiments of the present disclosure;

FIG. 13 is a flowchart illustrating selecting a payment method depending on the angle of an electronic device according to various embodiments of the present disclosure;

FIGS. 14A to 14C illustrate a method for changing a payment method depending on the angle of an electronic device according to various embodiments of the present disclosure;

FIG. 15 is a flowchart illustrating selecting payment information by using a plurality of antennas in an electronic device according to various embodiments of the present disclosure;

FIG. 16 illustrates a method for selecting payment information by using a plurality of antennas according to various embodiments of the present disclosure;

FIG. 17 is a flowchart illustrating controlling the time to select payment information on the basis of the intensity of a signal of an external device in an electronic device according to various embodiments of the present disclosure;

FIGS. 18A and 18B illustrate changing payment information on the basis of the intensity of a signal of an external device in an electronic device according to various embodiments of the present disclosure;

FIG. 19 is a flowchart illustrating controlling of the selection of payment information at the time of payment in an electronic device according to various embodiments of the present disclosure;

FIG. 20 is a flowchart illustrating notification of a change of payment information in an electronic device according to various embodiments of the present disclosure;

FIGS. 21A and 21B illustrate an interface for setting a payment means in an electronic device according to various embodiments of the present disclosure;

FIG. 22 is a flowchart illustrating a payment information change and user authentication according to various embodiments of the present disclosure; and

FIGS. 23A and 23B illustrate a payment method when a plurality of electronic devices is connected according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the terms “have”, “may have”, “include”, or “may include” refer to the existence of disclosed corresponding features (e.g., numerals, functions, operations, or constituent elements such as components), and do not preclude the presence or addition of one or more additional features.

In the present disclosure, the expression “A or B”, “at least one of A or/and B”, or “one or more of A or/and B” may include any and all possible combinations of the items listed. For example, the expression “A or B”, “at least one of A and B”, or “at least one of A or B” refers to all of (1) including at least one A, (2) including at least one B, or (3) including all of at least one A and at least one B.

Although terms such as “a first”, “a second”, “the first”, or “the second” used in various embodiments of the present disclosure may modify various elements of the various embodiments, these terms do not limit the corresponding elements. For example, these terms do not limit an order or an importance of the corresponding components. These terms may instead be used for the purpose of distinguishing one element from another element. For example, a first user device and a second user device may indicate different user devices although both of them are user devices. As an additional example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), the element may be directly connected or coupled directly to the other element, and there may be an intervening element (e.g., third element) interposed between the element and the other element. In contrast, it will be understood that when an element (e.g., first element) is referred to as being “directly connected,” or “directly coupled” to another element (second element), there is no intervening element (e.g., third element) interposed between them.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) used for performing the corresponding operations or a generic-purpose processor (e.g., a central processing unit (CPU) or an application processor (AP), that can perform a corresponding operation by executing one or more software programs stored in a memory device.

Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia player (PMP), a Moving Picture Experts Group phase 1 or phase 2 (MPEG-1 or MPEG-2) audio layer 3 (MP3) player, a mobile medical device, a camera, a power bank, or a wearable device (e.g., a head-mount-device (HMD), an electronic glasses, an electronic clothing, an electronic bracelet, an electronic watch, an electronic ring, an electronic anklet, an electronic necklace, an electronic accessory, or an electronic contact lens), a body-mounted type (e.g., a skin pad, or tattoo), and a bio-implantable type (e.g., an implantable circuit)).

An electronic device according to various embodiments of the present disclosure may be a home appliance. The home appliance may include at least one of: a television (TV), a digital versatile disc (DVD) player, an audio component, a refrigerator, an air conditioner, a vacuum cleaner, an oven, a microwave oven, a washing machine, an air cleaner, a set-top box, a home automation control panel, a security control panel, a TV box (e.g., Samsung HomeSync®, Apple TV®, or Google TVR), a game console (e.g., Xbox® or PlayStation®), an electronic dictionary, an electronic key, a camcorder, and an electronic photo frame.

According to an embodiment, the electronic device may include at least one of various medical devices (e.g., portable medical measuring devices (e.g., a blood glucose monitoring device, a heart rate monitoring device, a blood pressure measuring device, a body temperature measuring device, etc.), a magnetic resonance angiography (MRA) machine, a magnetic resonance imaging (MRI) machine, a computed tomography (CT) scanner, or an ultrasonic machine), a navigation device, a global positioning system (GPS) receiver, an event data recorder (EDR), a flight data recorder (FDR), an in-vehicle infotainment device, an electronic device for a ship (e.g., a ship navigation device or a gyrocompass), avionics devices, security devices, a head unit for a vehicle, a robot for home or industry, an automatic teller's machine (ATM) of a financial institution, point of sales (POS) device at a retail store, or an interne of things device (e.g., a light bulb, various sensors, an electric or gas meter, a sprinkler device, a fire alarm, a thermostat, a streetlamp, a toaster, sporting equipment, a hot water tank, a heater, a boiler, etc.).

According to various embodiments of the present disclosure, an electronic device may include at least one of a piece of furniture or a building or structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned devices. Additionally, the electronic device according to various embodiments of the present disclosure may be a flexible device. Further, it will be apparent to those skilled in the art that an electronic device according to an embodiment of the present disclosure is not limited to the aforementioned devices, and may include a new electronic device according to the development of technology.

Hereinafter, the term “user” may indicate a person who uses an electronic device or a device (e.g., an artificial intelligence electronic device) that uses the electronic device.

Hereinafter, various embodiments of the present disclosure describe technologies for making payment using generally a short range communication in an electronic device. Hereinafter, a near field communication (NFC) technology will be described as an example of a short range communication. However, the present disclosure is not limited to the NFC technology and may be similarly applied to other communication technologies (e.g., magnetic secure transmission (MST)).

The NFC technology is a non-contact short range wireless communication standard which enables wireless communication between electronic devices by low power within a range shorter than a predetermined range (e.g. 10 cm), by using a particular frequency (e.g. 13.56 MHz). NFC has the maximum transmission speed per second of 424 Kbps and has an excellent security based on a characteristic of proximity and an encoding technology. When an NFC technology is applied, a complicated pairing process is not required in the recognition between devices and thus the devices can recognize each other no later than 1/10 second. In particular, although the NFC technology is based on radio frequency identification (RFID) technology but it supports bidirectional communication. Further, a storage memory space is relatively large and thus the range of services to which the NFC technology can be applied is relatively wide.

In other words, the NFC is a wireless communication scheme (or design) in which data is directly exchanged between NFC devices and is a kind or type of RFID scheme (or design). A wireless communication scheme (or design) using the RFID is divided according to a used frequency. For example, there are an RFID of 13.56 MHz band used in a smart card, such as a traffic card or an access card and an RFID of 900 MHz band mainly used in physical distribution. The NFC corresponds to an RFID using a frequency of 13.56 MHz band, as in the smart card. However, unlike the smart card in which only unidirectional communication can be performed, the NFC enables bidirectional communication. Therefore, the NFC is different from the smart card serving only as a tag in which particular information is stored so as to be transmitted to a reader. The NFC may not only serve as a tag according to necessity, but also may support a function of recording information in the tag and may be used for a peer to peer (P2P) information exchange made between devices having an NFC function.

The NFC may generally support three wireless communication modes. Specifically, the NFC may support a P2P communication mode defined in International Organization for Standardization/International Electrotechnical Commission (ISO/IEC) 18092, a PCD1 mode defined in ISO/IEC 14443, and a VCD2 mode defined in ISO/IEC 15693. The PCD1 mode and the VCD2 mode may be used for communication between a reader and a tag.

The P2P mode may support communication at a link level between two NFC devices. For connection establishment, a client, i.e. an NFC P2P initiator may search for a host, i.e. an NFC P2P target and transmit data.

The NFC device may function as an NFC reader. In other words, since the NFC device may operate an electronic device having a tag therein in an active mode, the NFC device may function not only as a tag but also as a reader for reading the tag and a writer for inputting the tag. The NFC device may read and modify data stored in an NFC transponder. Therefore, a user may read a tag by using the NFC device as in a smart poster, thereby inquiring additional information. For example, when the NFC device touches a tag in which a uniform resource location (URL) address is stored, the NFC device may read the URL address and support access to a website of the URL address.

The NFC device may further function as a card in a card emulation mode. When the NFC device is operated like a smart card, an external NFC reader may not distinguish between the smart card and the NFC device. Therefore, a non-contact type payment or a ticketing service can be performed. When the electronic device is operated like an existing RFID card, the user may make the electronic device instead of an existing card touch a reader, thereby performing payment.

Software elements in an NFC system are as follows. A logical link control protocol (LLCP) connects and controls communication between layers. An NFC data exchange format (NDEF) message, which is a basic message structure, may include one or more NDEF records. The NDEF records may include a payload described according to the type, length and option identifier of the payload. The NDEF payload means application data included in the NDEF records. A record type definition (RTD) defines a record format related to a message exchange between the NFC device and the tag. The RTD is the record type according to each NFC and the name of the type, which may correspond to the NDEF records. An NDEF is to define a record format related to a message exchange made between a device compatible with an NFC forum and a tag, and is a standard exchange format related to a uniform resource identifier (URI), a smart poster, etc.

Communication using an NFC technology may be performed between an NFC tag and an electronic device having an NFC chipset embedded therein. When an NFC chipset is embedded in the electronic device (e.g. smart phone), the NFC chipset may record information, such as a contact or personal information, and may also be used as a tag reader. In an environment where the NFC tag and the electronic device having the NFC chipset therein communicate with each other, information transmission may be performed as follows.

First, the electronic device may receive URI information including a URL from an NFC tag. If the electronic device desires to merely receive object information, the electronic device may identify object information stored in a URI. Whereas, if the electronic device desires to access a content server, the electronic device may access a content server having, as an address, a URL transmitted from a tag and transmit a content request message. Therefore, the content server may transmit the requested content to the electronic device.

In addition to this, the NFC technology may be used in various designs or schemes. The NFC technology may be used for application services, such as the acquisition and connection of a URL address from a poster having a tag. In particular, compared with an RFID technology supporting a simple tag recognition service, the NFC technology can be applied to application services, which are more complicated and require mutual data communication, from a micropayment service, such as a virtual coupon service, a poster advertisement and ticket buying service, or a vending machine service, to a medical service. Furthermore, the NFC technology may also be applied to payment using the electronic device according to the present disclosure.

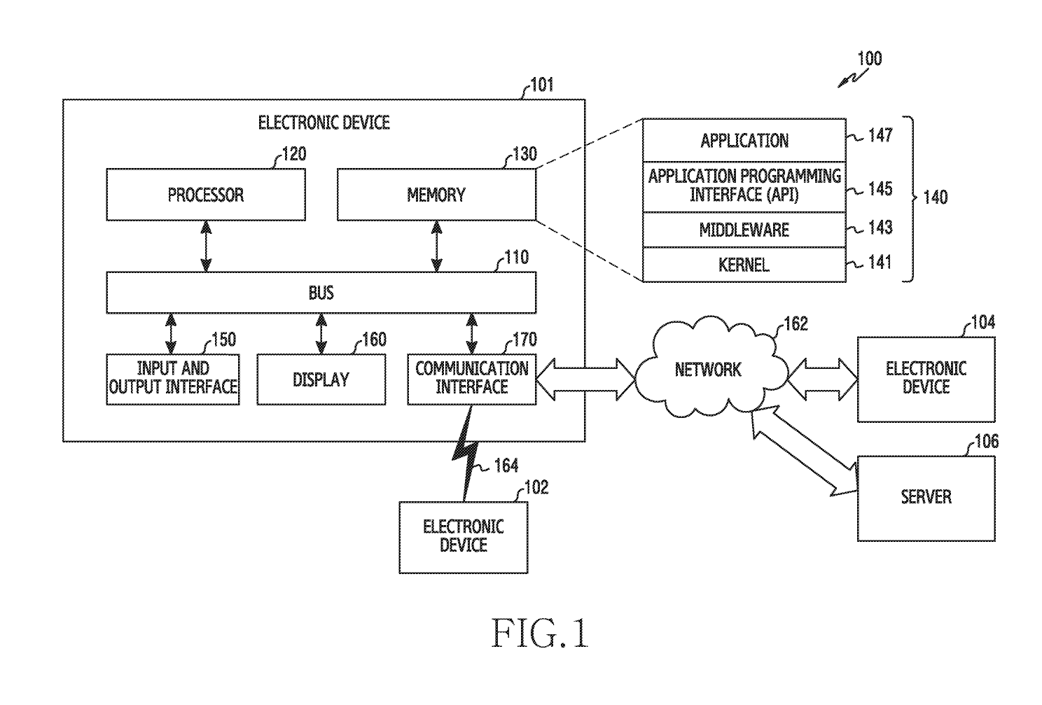

FIG. 1 is a diagram illustrating a network environment including an electronic device according to various embodiments of the present disclosure.

An electronic device 101 within a network environment 100, according to various embodiments, will be described with reference to FIG. 1. The electronic device 101 may include a bus 110, a processor 120, a memory 130, an input/output interface 150, a display 160, and a communication interface 170. According to an embodiment of the present disclosure, the electronic device 101 may omit at least one of the above components or may further include other components.

The bus 110 may include, for example, a circuit which interconnects the components 120 to 170 and delivers a communication (e.g., a control message or data) between the components 120 to 170.

The processor 120 may include one or more of a CPU, an AP, or a communication processor (CP). The processor 120 may perform operations or data processing with respect to control or communication of at least one other element of the electronic device 101. According to an embodiment of the present disclosure, the processor 120 may perform an operation to receive first proximity service data and receive second proximity service data included in the first proximity service data using guide information which is used for receiving the second proximity service data. In addition, the processor 120 may control transmission of the first proximity service data including guide information which is used for receiving the second proximity service data.

the memory 130 may include at least one of a volatile memory or a non-volatile memory. For example, the memory 130 may store commands or data related to at least one other element of the electronic device 101. According to an embodiment, the memory 130 may store at least one of software or programs 140. As illustrated in FIG. 1, the programs 140 may include at least one or more of a kernel 141, middleware 143, an application programming interface (API) 145, or an application program (or an application) 147, etc. At least part of the kernel 141, the middleware 143, or the API 145 may be referred to as an operating system (OS).

The kernel 141 may control or manage system resources (e.g., the bus 110, the processor 120, the memory 130, or the like) used for performing operations or functions implemented by the other programs (e.g., the middleware 143, the API 145, or the application program 147). Additionally, the kernel 141 may provide an interface for allowing the middleware 143, the API 145, or the application program 147 to access an individual element of the electronic device 101 and to control or manage the system resources.

The middleware 143 may serve as an intermediary for allowing the API 145 or the application program 147 to communicate with the kernel 141 and exchange data with the kernel 141. In addition, the middleware 143 may perform operations (e.g., scheduling or load balancing) for controlling work requests received from the application program 147, for example, by assigning a priority to each work request for using the system resources (e.g., the bus 110, the processor 120, the memory 130, or the like) of the electronic device 101 to at least one application of the application program 147.

The API 145 may be an interface for allowing the application 147 to control a function provided by the kernel 141 or the middleware 143, and may include, for example, at least one interface or function (e.g., instructions) for controlling a file, controlling a window, processing an image, or controlling a text.

The input/output interface 150 may serve as an interface for transmitting instructions or data input from a user or another external device to the other element(s) of the electronic device 101. Furthermore, the input/output interface 150 may output the instructions or data received from other element(s) of the electronic device 101 to the user or another external device.

Examples of the display 160 may include a liquid crystal display (LCD), a light-emitting diode (LED) display, an organic LED (OLED) display, a microelectromechanical systems (MEMS) display, and an electronic paper display. The display 160 may display, for example, various types of contents (e.g., text, images, videos, icons, or symbols) to a user. The display 160 may include a touch screen, and may receive, for example, a touch, gesture, proximity, or hovering input using an electronic pen or a user's body part.

The communication interface 170 may establish communication, for example, between the electronic device 101 and an external device (e.g., a first external electronic device 102, a second external electronic device 104, or a server 106). For example, the communication interface 170 may be connected to a network 162 through wireless or wired communication, and may communicate with an external device the second external electronic device 104 or the server 106).

The wireless communication may use at least one of for example, long term evolution (LIE), LIE-advanced (LTE-A), code division multiple access (CDMA), wideband CDMA (WCDMA), universal mobile telecommunications system (UMTS), wireless broadband (WiBro), and global system for mobile communications (GSM), as a cellular communication protocol. In addition, the wireless communication may include, for example, short range communication 164. The short-range communication 164 may include at least one of Wi-Fi, Bluetooth®, NFC, and global navigation satellite system (GNSS). GNSS may include, for example, at least one of GPS, global navigation satellite system (GLONASS), a BeiDou Navigation satellite system (hereinafter referred to as “BeiDou”), or European global satellite-based navigation system (GALILEO), based on a location, a bandwidth, or the like. Hereinafter, in the present disclosure, the “GPS” may be interchangeably used with the “GNSS”. The wired communication may include, for example, at least one of a universal serial bus (USB), a high definition multimedia interface (HDMI), recommended standard-232 (RS-232), and a plain old telephone service (POTS). The network 162 may include at least one of a communication network such as a computer network (e.g., a local area network (LAN) or a wide area network (WAN)), the internet, and a telephone network.

Each of the first and second external electronic devices 102 and 104 may be of a type identical to or different from that of the electronic device 101. According to an embodiment of the present disclosure, the server 106 may include a group of one or more servers. According to various embodiments of the present disclosure, all or some of the operations performed in the electronic device 101 may be executed in another electronic device or a plurality of electronic devices (e.g., the electronic devices 102 and 104 or the server 106). According to an embodiment of the present disclosure, when the electronic device 101 performs functions or services automatically or in response to a request, the electronic device 101 may request another device (e.g., the electronic device 102 or 104 or the server 106) to execute at least some functions relating thereto instead of or in addition to autonomously performing the functions or services. Another electronic device the electronic device 102 or 104, or the server 106) may execute the requested functions or the additional functions, and may deliver a result of the execution to the electronic device 101. The electronic device 101 may process the received result as it is or further process the received result to provide the requested functions or services. To this end, for example, cloud computing, distributed computing, or client-server computing technologies may be used.

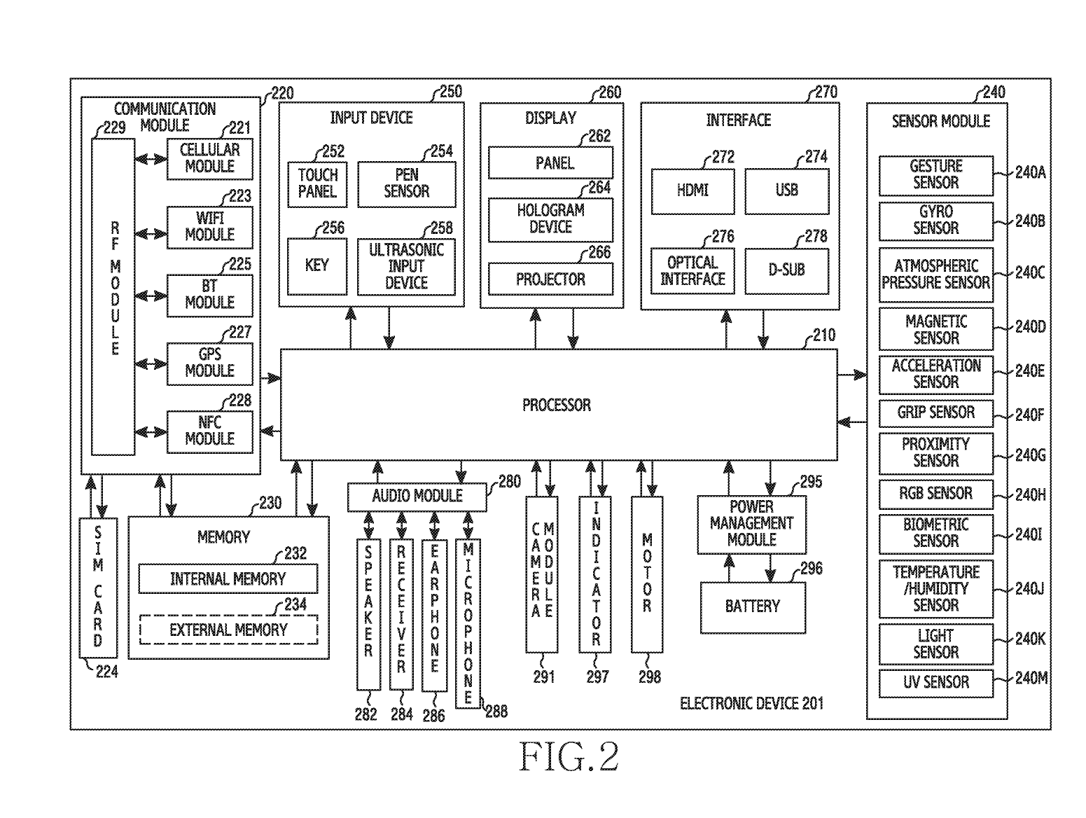

FIG. 2 is a block diagram illustrating an electronic device according to various embodiments of the present disclosure.

Referring to FIG. 2, the electronic device 201 may include, for example, all or a part of the electronic device 101 shown in FIG. 1. The electronic device 201 may include one or more processors 210 (e.g., APs), a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298.

The processor 210 may control a plurality of hardware or software components connected thereto and perform processing of pieces of data and calculations by driving an OS or an application program. The processor 210 may be embodied as, for example, a system on chip (SoC). According to an embodiment of the present disclosure, the processor 210 may further include at least a graphics processing unit (GPU) or an image signal processor (ISP). The processor 210 may include at least some of the components (e.g., a cellular module 221) illustrated in FIG. 2. The processor 210 may load, into a volatile memory, commands or data received from at least one other component (a non-volatile memory) into a volatile memory to process the loaded commands or data, and may store various data in a non-volatile memory.

The communication module 220 may have a configuration equal or similar to that of the communication interface 170 of FIG. 1. The communication module 220 may include, for example, a cellular module 221, a Wi-Fi (WIFI) module 223, a Bluetooth® (BT) module 225, a GPS module 227 (e.g., a GPS module 227, a GLONASS module, a BeiDou module, or a GALILEO module), an NFC module 228, and an RF module 229.

The cellular module 221, for example, may provide a voice call, a video call, a text message service, or an Internet service through a communication network. According to an embodiment of the present disclosure, the cellular module 221 may distinguish and authenticate the electronic device 201 in a communication network using a subscriber identification module 224 (e.g., the SIM card). According to an embodiment of the present disclosure, the cellular module 221 may perform at least some of the functions that the AP 210 may provide. According to an embodiment of the present disclosure, the cellular module 221 may include a CP.

Each of the Wi-Fi module 223, the BT module 225, the GNSS or GPS module 227, and the NFC module 228 may include a processor for processing data transmitted/received through a corresponding module. According to an embodiment of the present disclosure, at least some (e.g., two or more) of the cellular module 221, the Wi-Fi module 223, the BT module 225, the GNSS module 227, and the NFC module 228 may be included in a single integrated chip (IC) or IC package.

The RF module 229, for example, may transmit/receive a communication signal (e.g., an RF signal). The RF module 229 may include, for example, a transceiver, a power amplifier module (PAM), a frequency filter, a low noise amplifier (LNA), and an antenna. According to an embodiment of the present disclosure, at least one of the cellular module 221, the Wi-Fi module 223, the BT module 225, the GNSS module 227, and the NFC module 228 may transmit/receive an RF signal through a separate RF module.

The SIM 224 may include, for example, a card including a subscriber identity module or an embedded SIM, and may further include unique identification information (e.g., an integrated circuit card identifier (ICCID)) or subscriber information (e.g., an international mobile subscriber identity (IMSI)).

The memory 230 (e.g., the memory 130) may include, for example, an embedded (or internal) memory 232 or an external memory 234. The embedded memory 232 may include at least one of a volatile memory (e.g., a dynamic random access memory (DRAM), a static RAM (SRAM), a synchronous DRAM (SDRAM), or the like) and a non-volatile memory (e.g., a one time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory), a hard disc drive, or a solid state drive (SSD)).

The external memory 234 may further include a flash drive, for example, a compact flash (CF), a secure digital (SD), a micro-SD, a mini-SD, an extreme digital (xD), a multimedia card (MMC), a memory stick, or the like. The external memory 234 may be functionally and/or physically connected to the electronic device 201 through various interfaces.

The sensor module 240 may be configured to measure a physical quantity or detect an operation state of the electronic device 201, and convert the measured or detected information into an electrical signal. The sensor module 240 may include, for example, at least one of a gesture sensor 240A, a gyro sensor 240B, an atmospheric pressure sensor (barometer) 240C, a magnetic sensor 240D, an acceleration sensor 240E, a grip sensor 240F, a proximity sensor 240G, a color sensor 240H (e.g., red, green, and blue (RGB) sensor), a biometric sensor (medical sensor) 240I, a temperature/humidity sensor 240J, alight sensor 240K, and an ultraviolet light (UV) sensor 240M. Additionally or alternatively, the sensor module 240 may further include one or more sensors (not shown), including an electronic nose (E-nose) sensor, an electromyography (EMG) sensor, an electroencephalogram (EEG) sensor, an electrocardiogram (ECG) sensor, an infrared (IR) sensor, an iris scan sensor, and a finger scan sensor. The sensor module 240 may further include a control circuit for controlling one or more sensors included therein. According to an embodiment of the present disclosure, the electronic device 201 may further include another processor configured to control the sensor module 240, as a part of the processor 210 or a separate component from the processor 210 in order to control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. The touch panel 252 may further include a control circuit. The touch panel 252 may further include a tactile layer, and provide a tactile reaction to the user.

The (digital) pen sensor (digital pen or stylus) 254 may include, for example, a recognition sheet which is a part of the touch panel or is separated from the touch panel. The key 256 may include, for example, a physical button, an optical key or a keypad. The ultrasonic input device 258 may detect, through a microphone (e.g., the microphone 288), ultrasonic waves generated by an input tool, and identify data corresponding to the detected ultrasonic waves.

The display 260 (e.g., the display 160) may include a panel 262, a hologram device 264, or a projector 266. The panel 262 may include a configuration identical or similar to the display 160 illustrated in FIG. 1. The panel 262 may be implemented to be, for example, flexible, transparent, or wearable. The panel 262 may be embodied as a single module with the touch panel 252. The hologram device 264 may show a three dimensional (3D) image in the air by using an interference of light. The projector 266 may project light onto a screen to display an image. The screen may be located, for example, in the interior of or on the exterior of the electronic device 201. According to an embodiment of the present disclosure, the display 260 may further include a control circuit for controlling the panel 262, the hologram device 264, or the projector 266.

The interface 270 may include, for example, an HDMI 272, a USB 274, an optical interface 276, or a D-subminiature (D-sub) 278. The interface 270 may be included in, for example, the communication interface 170 illustrated in FIG. 1. Additionally or alternatively, the interface 270 may include, for example, a mobile high-definition link (MIR) interface, an SD card/MMC interface, or an infrared data association (IrDA) standard interface.

As illustrated in FIG. 2, the audio module 280, for example, may be configured to bilaterally convert a sound and an electrical signal. At least some components of the audio module 280 may be included in, for example, the input/output interface 150 illustrated in FIG. 1. The audio module 280 may process voice information input or output through, for example, a speaker 282, a receiver 284, earphones 286, or the microphone 288.

The camera module 291 is, for example, a device which may photograph a still image, a moving image, or a video. According to an embodiment of the present disclosure, the camera module 291 may include one or more image sensors (e.g., a front sensor or a rear sensor), a lens, an ISP or a flash (e.g., LED or xenon lamp).

The power management module 295 may manage, for example, power of the electronic device 201. According to an embodiment of the present disclosure, the power management module 295 may include a power management (PMIC), a charger IC, or a battery or fuel gauge. The PMIC may use a wired and/or wireless charging method. Examples of the wireless charging method may include, for example, a magnetic resonance method, a magnetic induction method, an electromagnetic wave method, and the like. Additional circuits (e.g., a coil loop, a resonance circuit, a rectifier, etc.) for wireless charging may he further included. The battery gauge may measure, for example, a residual quantity of the battery 296, and a voltage, a current, or a temperature while charging. The battery 296 may include, for example, at least one of a rechargeable battery and a solar battery.

The indicator 297 may indicate a state (e.g., a booting state, a message state, a charging state, or the like) of the electronic device 201 or apart (e.g., the processor 210) of the electronic device 201. The motor 298 may convert an electrical signal into a mechanical vibration, and may generate a vibration, a haptic effect, or the like. Although not illustrated, the electronic device 201 may include a processing device (e.g., a GPU) for supporting a mobile TV. The processing device for supporting a mobile TV may process, for example, media data according to certain standards such as digital multimedia broadcasting (DMB), digital video broadcasting (DVB), or media flow.

Each of the above-described hardware components of the electronic device 201 according to the present disclosure may be configured with one or more components, and the names of the corresponding component elements may vary based on the type of electronic device. In various embodiments, the electronic device may include at least one of the above-described elements. Some of the above-described elements may he omitted from the electronic device, or the electronic device may further include additional elements. Also, some of the hardware components according to various embodiments may be combined into one entity, which may perform functions identical to those of the relevant components before the combination.

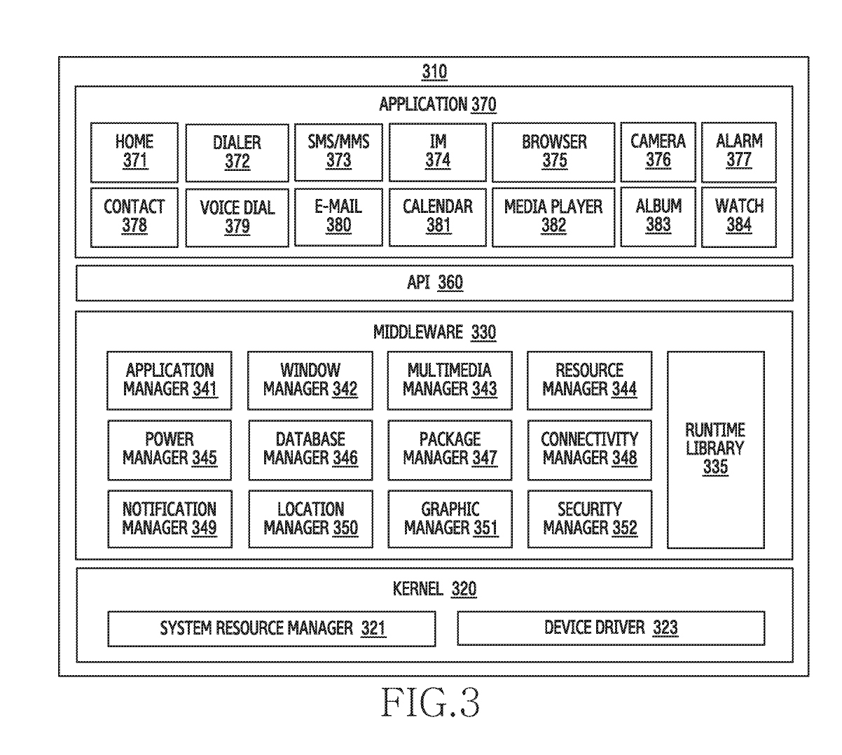

FIG. 3 is a block diagram illustrating a program module according to various embodiments of the present disclosure.

Referring to FIG. 3, according to an embodiment of the present disclosure, the program module 310 (e.g., the program 140) may include an OS for controlling resources related to the electronic device (e.g., the electronic device 101) and/or various applications (e.g., the application 147) executed in the OS. The OS may be, for example, Android®, iOS®, Windows®, Symbian®, Tizen®, Bada®, or the like.

The program module 310 may include at least one of a kernel 320, middleware 330, an API 360, and an application 370. At least some of the program module 310 may be preloaded on an electronic device, or may be downloaded from an external electronic device (e.g., the electronic device 102, the electronic device 104, or the server 106).

The kernel 320 (e.g., the kernel 141) may include, for example, a system resource manager 321 or a device driver 323. The system resource manager 321 may control, allocate, or collect system resources. According to an embodiment of the present disclosure, the system resource manager 321 may include a process management unit, a memory management unit, or a file system management unit, and the like. The device driver 323 may include, for example, a display driver, a camera driver, a Bluetooth® driver, a shared memory driver, a USB driver, a keypad driver, a Wi-Fi driver, an audio driver, or an inter-process communication (IPC) driver.

For example, the middleware 330 illustrated in FIG. 3 may provide a function utilized in common by the application 370, or may provide various functions to the applications 370 through the API 360 so as to enable the applications 370 to efficiently use limited system resources in the electronic device. According to an embodiment of the present disclosure, the middleware 330 (e.g., the middleware 143) may include at least one of a run time library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include a library module that a compiler uses in order to add a new function through a programming language while an application 370 is being executed. The runtime library 335 may perform input/output management, memory management, or a functionality for an arithmetic function, or the like.

The application manager 341 may manage, for example, a life cycle of at least one of the applications 370. The window manager 342 may manage graphical user interface (GUI) resources used by a screen. The multimedia manager 343 may identify a format utilized for reproduction of various media files, and may encode or decode a media file by using a codec suitable for the corresponding format. The resource manager 344 may manage resources such as a source code, a memory, and a storage space of at least one of the applications 370.

The power manager 345 may operate together with, for example, a basic input/output (BIOS) or the like to manage a battery or power source and may provide power information utilized for operation of the electronic device. The database manager 346 may generate, search, or change a database to be used by at least one of the applications 370. The package manager 347 may manage installation or update of an application distributed in the format of a package file.

For example, the connectivity manager 348, as illustrated in FIG. 3, may manage wireless connectivity such as Wi-Fi or Bluetooth®. The notification manager 349 may display or notify of an event such as an arrival message, promise, proximity notification, and the like in such a way that does not disturb a user. The location manager 350 may manage location information of an electronic device. The graphic manager 351 may manage a graphic effect which will be provided to a user, or a user interface related to the graphic effect. The security manager 352 may provide security functions utilized for system security or user authentication, or the like. According to an embodiment of the present disclosure, when the electronic device (e.g., the electronic device 101) has a telephone call function, the middleware 330 may further include a telephony manager for managing a voice call function or a video call function of the electronic device.

The middleware 330 may include a middleware module that forms a combination of various functions of the above-described components. The middleware 330 may provide a module specialized for each type of OS in order to provide a differentiated function. Further, the middleware 330 may dynamically remove or delete some of the existing components or add new components.

The API 360 (e.g., the API 145) includes, for example, a set of API programming functions, and may be provided with different configurations according to OSs. For example, in the case of Android® or iOS®, one API set may be provided for each platform. In the case of Tizen®, two or more API sets may be provided for each platform.

The applications 370 (e.g., the application 147) may include, for example, one or more applications which may provide functions such as a home 371, a dialer 372, a short message service (SMS)/multimedia message service (MMS) 373, an instant message (IM) 374, a browser 375, a camera 376, an alarm 377, contacts 378, a voice dial 379, an e-mail 380, a calendar 381, a media player 382, an album 383, a clock (or watch) 384, a health care (e.g., to measure exercise quantity or blood sugar), or environment information (e.g., atmospheric pressure, humidity, or temperature information).

According to an embodiment of the present disclosure, the applications 370, illustrated in FIG. 3, may include an application (hereinafter, referred to as an “information exchange application” for convenience of description) that supports information exchange between the electronic device (e.g., the electronic device 101) and an external electronic device (e.g., the electronic device 102 or 104). The information exchange application may include, for example, a notification relay application for transferring specific information to an external electronic device or a device management application for managing an external electronic device.

For example, the notification relay application may include a function of transferring, to an external electronic device (e.g., the electronic device 102 or 104 in FIG. 1), notification information generated from other applications of the electronic device 101 (e.g., an SMS/MMS application, an e-mail application, a health management application, or an environmental information application). Further, the notification relay application may receive notification information from, for example, an external electronic device and provide the received notification information to a user.

A device management application may manage (e.g., install, delete, or update), for example, at least one function of an external electronic device (e.g., the electronic device 102 or 104) communicating with the electronic device (e.g., a function of turning on/off the external electronic device itself (or some components thereof) or a function of adjusting a brightness (or a resolution) of the display), applications operating in the external electronic device, and services provided by the external electronic device (e.g., a call service or a message service).

According to an embodiment of the present disclosure, the applications 370 may include applications (e.g., a health care application of a mobile medical appliance or the like) designated according to attributes corresponding to an external electronic device (e.g., attributes of the electronic device 102 or 104). According to an embodiment of the present disclosure, the applications 370 may include an application received from an external electronic device (e.g., the server 106, or the electronic device 102 or 104 in FIG. 1). According to an embodiment of the present disclosure, the applications 370 may include a preloaded application or a third party application that may be downloaded from a server. The names of the components of the program module 310, according to the embodiment illustrated in FIG. 3, may vary according to the type of OS.

According to some embodiments, at least a part of the program module 310 may be implemented in software, firmware, hardware, or a combination of two or more thereof. At least some of the program module 310 may be implemented (e.g., executed) by, for example, the processor (e.g., the processor 210). At least some of the program module 310 may include, for example, a module, a program, a routine, a set of instructions, and/or a process for performing one or more functions.

According to an embodiment, the applications 370 may include an application (hereinafter, referred to as an “information exchange application” for convenience of description) supporting information exchange between the electronic device (for example, the electronic device 101) and an external electronic device (for example, the electronic device 102 or 104). The information exchange application may include, for example, a notification relay application for transferring specific information to the external electronic device or a device management application for managing the external electronic device.

For example, the notification relay application may include a function of transferring, to the external electronic device (for example, the electronic device 102 or 104), notification information generated from other applications of the electronic device (for example, an SMS/MMS application 373, an e-mail application 380, a health care application (not shown), or an environmental information application (not shown)). Further, the notification relay application may receive notification information from, for example, an external electronic device and provide the received notification information to a user.

The device management application may manage (for example, install, delete, or update), for example, at least one function of an external electronic device (for example, the electronic device 102 or 104) communicating with the electronic device (for example, a function of turning on/off the external electronic device itself (or sonic components) or a function of adjusting the luminance (or resolution) of a display), applications operating in the external electronic device, or services provided by the external electronic device (for example, a call service and a message service).

According to an embodiment, the applications 370 may include applications (for example, a health care application of a mobile medical appliance or the like) designated according to attributes of the external electronic device (e.g. the electronic device 102 or 104). According to an embodiment, the applications 370 may include an application received from the external electronic device (for example, a server 106, or the electronic device 102 or 104). According to an embodiment, the applications 370 may include a preloaded application or a third party application which can be downloaded from a server. Names of the elements of the program module 310 according to the illustrated embodiments may change depending on the type of OS.

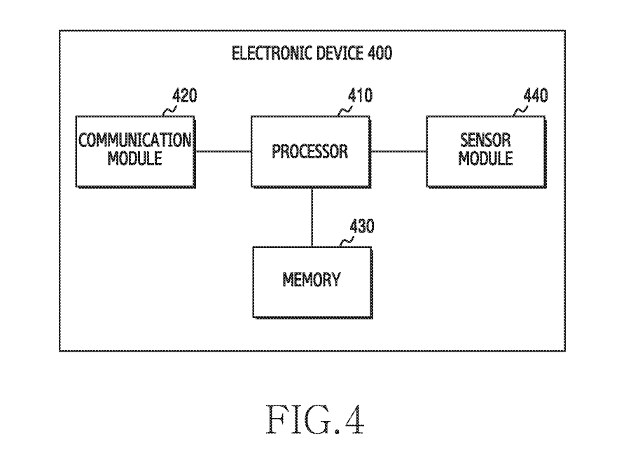

FIG. 4 illustrates a configuration of an electronic device according to various embodiments of the present disclosure:

Referring to FIG. 4, according to various embodiments, an electronic device 400 may include: a sensor module 440 that senses a state of the electronic device and generates a signal related to a sensed result; a processor 410 that determines the state of the electronic device by using the sensed result and identifies payment information; and a communication module 420 that receives a payment information request signal from an external device and transmits, to the external device, the payment information identified by the processor 410. Further, the electronic device 400 may further include a memory 430 for storing the payment information in a process of selecting the payment information on the basis of the determined state of the electronic device. The payment information may include the kind of a payment card and/or a payment method (e.g. payment by installment or lump-sum payment, whether coupons or points are used). The electronic device 400 may correspond to the electronic device 101 in FIG. 1. Further, the processor 410, the communication module 420, the memory 430, and the sensor module 440 may correspond to the processor 210, the communication 220, the memory 230, and the sensor module 240, respectively.

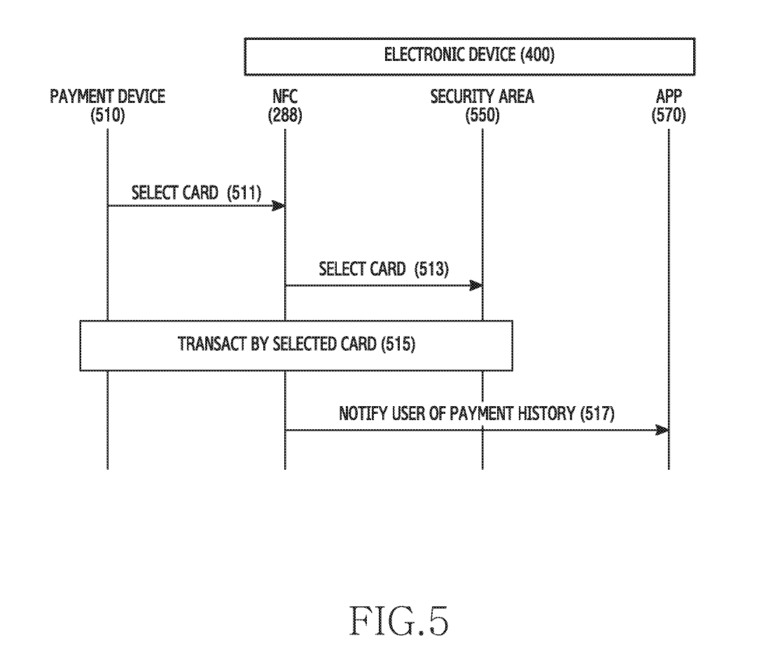

FIG. 5 illustrates a signal exchange between an electronic device and a payment device at the time of payment using the electronic device according to various embodiments of the present disclosure. Referring to FIG. 5, a payment device 510 has a short range communication (e.g. NFC) reader function and receives card information from the electronic device 400 in FIG. 4. For example, the payment device 510 may be referred to as “a point of sale (POS)”.

Referring to FIG. 5, in operation 511, the payment device 510 may send a request for card data to a NFC module 288 of the electronic device 400. The NFC module 288 may include an antenna for short range communication. Although not illustrated in FIG. 4, prior to operation 511, a series of setting operations may be performed for non-contact data connection between the payment device 510 and the NFC module 288.

In operation 513, the NFC module 288 may send a request for card information to a secure storage module 550. In operation 515, a transaction may be performed by using the card information stored in the secure storage module 550. For example, payment may be performed by a selected card. The payment may be performed through a secure transaction between the card and the payment device 510. According to an embodiment, the secure storage module 550 may transfer a location of payment information (e.g. information on a card to be used for payment) to the NFC module 288. The NFC module 288 may transmit the location of payment information to the payment device 510. The payment device 510 may identify card information in the received location of payment information and process payment,

In operation 517, as illustrated in FIG. 5, the NFC module 288 may transmit user notification of payment information to an application 570. Therefore, the application 570 may notify of payment completion to a user through an interface of the electronic device 400. For example, the application 570 may display a notification window notifying of the payment completion or output a notification sound/vibration notifying of the payment completion.

According to an embodiment, the electronic device 400 may perform a payment operation by using a short range communication. According to various embodiments of the present disclosure, a card to be used for payment may be changed. For example, in operation 513 or 515 of FIG. 5, a card to be used for payment may be changed. Hereinafter, various embodiments for changing a card will be described.

According to various embodiments of the present disclosure, the electronic device may include: a housing; a communication module that is disposed inside the housing and wirelessly transmits information on at least one card to an external device; a sensor that senses an orientation of the electronic device and generates a first signal; a processor that is electrically connected to the wireless communication module and the sensor; and a memory that is electrically connected to the processor and at least temporarily stores one of first card information and second card information. The memory, at the time of execution, may include or store instructions which instruct the processor to: receive the first signal; select one of the first card information and the second card information, at least partially on the basis of the first signal; and wirelessly transmit the selected card information to the external device.

The instructions may include at least one instruction which instructs the processor to store the first card information as card information used as a default.

The instructions may include at least one instruction which instructs the processor to wirelessly transmit, to an external device, the second card information as the selected card information, in place of the first card information, at least partially on the basis of the first signal.

The first card information or the second card information may include at least one of credit card information, a token associated with the credit card, membership information, coupon information, cash card information, user identification card information, and traffic card information.

The instructions may include at least one instruction which instructs the processor to wirelessly transmit the selected card information to the external device on the basis of the authentication of a user of the electronic device.

The instructions may include at least one instruction which instructs the processor to provide at least one feedback in response to the selection, wherein the feedback may include at least one of a voice, a vibration, and a user interface displayed on a display of the electronic device.

The instructions may include an instruction which instructs the processor to select card information when an orientation of the electronic device is changed, when the intensity of a signal received from the external device exceeds a threshold value, or when a payment information request signal is received from the external device.

The electronic device may further include a display unit that displays a screen for inputting a corresponding relationship between multiple orientations of the electronic device and multiple pieces of card information and sets the corresponding relationship according to a user input.

The memory may at least temporarily store first payment scheme (or design) information and second payment scheme (or design) information, wherein the instructions may include instructions which instruct the processor to: select one of the first payment scheme information and the second payment scheme information, at least partially on the basis of the first signal; and wirelessly transmit the selected payment scheme information to the external device.

The communication module may receive a second signal from another electronic device, wherein the instructions may include instructions which instruct the processor to: receive the second signal; and select the first card information and/or the second card information, at least partially on the basis of the second signal, wherein the second signal may include orientation information of the another electronic device.

According to an embodiment of the present disclosure, an electronic device may include: a housing; a communication module that is disposed inside the housing and wirelessly transmits information on at least one card to an external device; a sensor that senses an angle which one axis of the electronic device has with respect to an external reference axis and generates a signal; a processor that is electrically connected to the wireless communication module and the sensor; and a memory that is electrically connected to the processor and at least temporarily stores first card information and second card information. The memory, at the time of execution, may include or store instructions which instruct the processor to: connect a case where the angle is a first angle with the first card information; connect a case where the angle is a second angle with the second card information; select the first card information when the signal corresponds to the first angle; select the second card information when the signal corresponds to the second angle; and wirelessly transmit the selected card information to the external device.

The instructions may include at least one instruction which instructs the processor to store the first card information as card information used as a default.

The instructions may further include at least one instruction which instructs the processor to wirelessly transmit, to the external device, the second card information as the selected card information, in place of the first card information, at least partially on the basis of the signal.

The first card information and the second card information may include at least one of credit card information, a token associated with the credit card, membership information, coupon information, cash card information, user identification card information, and traffic card information.

The instructions may include at least one instruction which instructs the processor to wirelessly transmit the selected card information to the external device on the basis of the authentication of a user of the electronic device.

The instructions may include at least one instruction which instructs the processor to provide at least one feedback in response to the selection, wherein the feedback may include at least one of a voice, a vibration, and a user interface displayed on a display of the electronic device.

The instructions may include an instruction which instructs the processor to select card information when an angle of the electronic device is changed, when the intensity of a signal received from the external device exceeds a threshold value, or when a payment information request signal is received from the external device.

The electronic device may further include a display unit (e.g., display 160 in FIG. 1) that displays a screen for inputting a corresponding relationship between multiple angles of the electronic device and multiple pieces of card information and sets the corresponding relationship according to a user input.

The memory (e.g., memory 230 in FIG. 2) may at least temporarily store first payment scheme information and second payment scheme information, wherein the instructions may include instructions which instruct the processor to: connect a case where the angle is a first angle with the first payment scheme information; connect a case where the angle is a second angle with the second payment scheme information; select the first payment scheme information when the signal corresponds to the first angle; select the second payment scheme information when the signal corresponds to the second angle; and wirelessly transmit the selected payment scheme information to the external device.

The communication module e.g., communication module in FIG. 2 may receive a second signal from another electronic device, wherein the instructions may include instructions which instruct the processor to: receive the second signal; and select the first card information and/or the second card information, at least partially on the basis of the second signal, wherein the second signal may include information on angle of the another electronic device with respect to a reference axis.

According to an embodiment of the present disclosure, an electronic device may include: a housing; a processor that is arranged inside the housing and selects information on payment on the basis of a state of the electronic device; and a communication module that transmits the information to an external device, wherein the state may include at least one of an orientation of the electronic device, an angle with respect to a reference axis, and an antenna used to communicate with the external device.

The antenna may include one of at least one antenna included in the electronic device and at least one antenna included in another device which is connected to the electronic device.

The information on the payment may include a card used for payment and/or a payment scheme.

The processor may fix the information on the payment through authentication.

The electronic device may further include an output unit that outputs feedback which notifies of a change in the information on the payment, wherein the feedback may include at least one of a sound, a vibration, and a screen display.

The information on the payment may be selected when the state of the electronic device is changed, when the intensity of a signal received from the external device exceeds a threshold value, or when a payment information request signal is received from the external device.

The electronic device may further include a display unit that displays a screen for inputting a corresponding relationship between multiple states and multiple pieces of information on the payment.

The communication module may receive a signal from another electronic device, the processor may select the information on the payment on the basis of the signal, and the signal may include information on the state of the another electronic device.

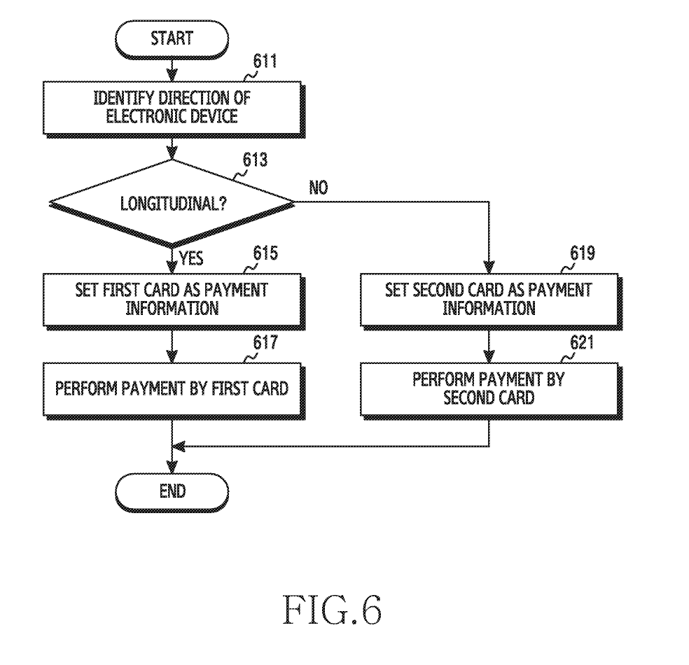

FIG. 6 is a flowchart illustrating selecting, depending on the direction of an electronic device, a payment means and performing payment according to various embodiments of the present disclosure. The operation as in FIG. 6 may be performed by the electronic device 400 in FIG. 4, and may be processed by, for example, the sensor module 440, the processor 410, or the communication module 420 (illustrated in FIG. 4).

Referring to FIG. 6, the electronic device 400 (illustrated in FIG. 4) may identify the direction of the electronic device 400 in operation 611. For example, the sensor module 440 placed inside the electronic device 400 may include a terrestrial magnetism sensor and may detect the direction of the electronic device 400. The sensor module 440 may generate a signal corresponding to the direction and transmit the generated signal to the processor 410.

The electronic device 400 may determine, in operation 613, whether the direction of the electronic device 400 is transverse or longitudinal. For example, the processor 410 may determine whether the direction of the electronic device 400 is transverse or longitudinal on the basis of a signal transmitted from the sensor module 440. The processor 410 may apply a threshold value in order to determine whether the direction of the electronic device 400 is transverse on the basis of the signal transmitted from the sensor module 440. For example, a threshold value may be set for dividing the direction of the electronic device 400 into the transverse direction and the longitudinal direction, and when the threshold value is satisfied, the direction may be deemed to be transverse. On the contrary, a threshold value may be set for dividing the direction of the electronic device 400 into the transverse direction and the longitudinal direction, and when the threshold value is not satisfied, the direction may be deemed to be longitudinal. Further, the reverse is possible.

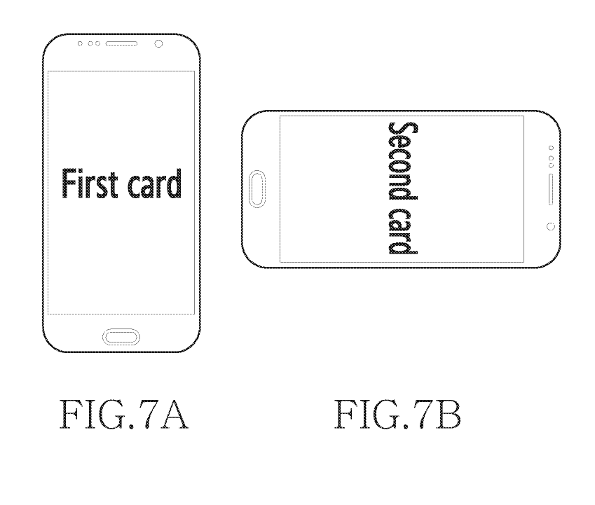

With reference to FIG. 6, when the state of the electronic device 400 is determined to be longitudinal in operation 613, the electronic device 400 may set a first card as payment information in operation 615. For example, operation 615 may be performed in a situation as illustrated in FIG. 7A. Payment means information (e.g. card information) may be temporarily or non-temporarily stored in the memory 430 placed inside the electronic device 400. For example, when the state of the electronic device is determined to be longitudinal, the processor 410 may select, as a payment means, a first card temporarily or non-temporarily stored in the memory 430.

The electronic device 400 may perform payment by the first card in operation 617. For example, when the first card has been set as payment information in operation 615, the communication module 420 placed inside the electronic device 400 may wiredly or wirelessly transmit first card information to an external device. For example, the electronic device 400 may transmit, to an external payment device, information on payment corresponding to the first card. Accordingly, the electronic device 400 may perform payment by the first card.

According to an embodiment, when the state of the electronic device 400 is determined to be transverse in operation 613, the electronic device 400 may set a second card as payment information in operation 619. For example, operation 619 may be performed in a situation as illustrated in FIG. 7B hereinafter. Payment means information may be temporarily or non-temporarily stored in the memory 430 placed inside the electronic device 400. For example, when the state of the electronic device is determined to be transverse, the processor 410 may select, as a payment means, a second card temporarily or non-temporarily stored in the memory 430.

According to an embodiment, the electronic device 400 of FIG. 4 may perform payment by the second card in operation 621, as illustrated in FIG. 6. For example, when the second card has been set as payment information in operation 619, the communication module 420 placed inside the electronic device 400 may wiredly or wirelessly transmit second card information to an external device. For example, the electronic device 400 may transmit, to an external payment device, information on payment corresponding to the second card. Accordingly, the electronic device 400 may perform payment by the second card.

The first card information or the second card information may include at least one of credit card information, a token associated with the credit card, membership information, coupon information, cash card information, user identification card information, and traffic card information. For example, the first card may correspond to a credit card of a company “A” and the second card may correspond to a credit card of a company “B”. In this case, if payment is performed when the electronic device is in a longitudinal state, the credit card of the company “A” may be selected as a payment means, and if payment is performed when the electronic device is in a transverse state, the credit card of the company “B” may be selected as a payment means. As another example, the first card may correspond to a credit card and the second card may correspond to a check card. In this case, if payment is performed when the electronic device is in a longitudinal state, the credit card may be selected as a payment means, and if payment is performed when the electronic device is in a transverse state, the check card may be selected as a payment means.

According to the embodiment illustrated in FIG. 6, in the case where there is a first electronic device including a payment function and a second electronic device connected thereto, when payment is performed by the first electronic device, information to be used for payment among payment information stored in two electronic devices may be selected on the basis of the direction of the first electronic device. For example, where the direction of the first electronic device is transverse when payment is performed using the first electronic device, the payment may be performed using card information included in the first electronic device. Further, when the direction of the first electronic device is longitudinal, the payment may be performed using card information included in the second electronic device. Further, the reverse is possible.

FIGS. 7A and 7B illustrate changing a payment means depending on a change of the direction of an electronic device according to various embodiments of the present disclosure. FIGS. 7A and 7B illustrate examples of two states. However, according to an embodiment of the present disclosure, when three or more payment means are considered, three or more states may be defined.

The electronic device (e.g. electronic device 400 in FIG. 4) may be in a longitudinal state as illustrated in FIG. 7A or the electronic device may be in a transverse state as in FIG. 7B. The direction may be identified using the sensor module 440 included in the electronic device 400 of FIG. 4. In the examples of FIGS. 7A and 7B, a first card may correspond to a longitudinal state and a second card may correspond to a transverse state. For example, when payment is performed while the electronic device 400 is in a longitudinal state, the electronic device 400 may be set such that the payment is performed by the first card. Further, when payment is performed while the electronic device 400 is in a transverse state, the electronic device 400 may be set such that the payment is performed by the second card. According to an embodiment of the present disclosure, a second card may correspond to a longitudinal state and a first card may correspond to a transverse state. Therefore, the processor 410 may select a card to be used for payment on the basis of the direction of the electronic device 400. For example, when the electronic device 400 is tagged to the device 510 of FIG. 5 in a longitudinal direction, the first card, which has been set to be used when payment is performed while the electronic device 400 is in a longitudinal state, may be used as a payment means. Further, when the electronic device is tagged to the device 510 in a transverse direction, the second card, which has been set to be used when payment is performed while the electronic device 400 is in a transverse state, may be used as a payment means.

According to an embodiment, as illustrated in FIGS. 7A and 7B, the electronic device 400 may display information indicating a selected card through a display unit. The display unit may include an output device (output unit), such as an image display, a speaker, or a motor (vibration notification). For example, the information indicating the selected card may be displayed in the form of a character or a figure. As another example, the information indicating the selected card may be displayed in the form of at least one of a character, a figure, a sound, a vibration, a graphic, and a color. Further, according to an embodiment of the present disclosure, the information indicating the selected card may not be displayed.

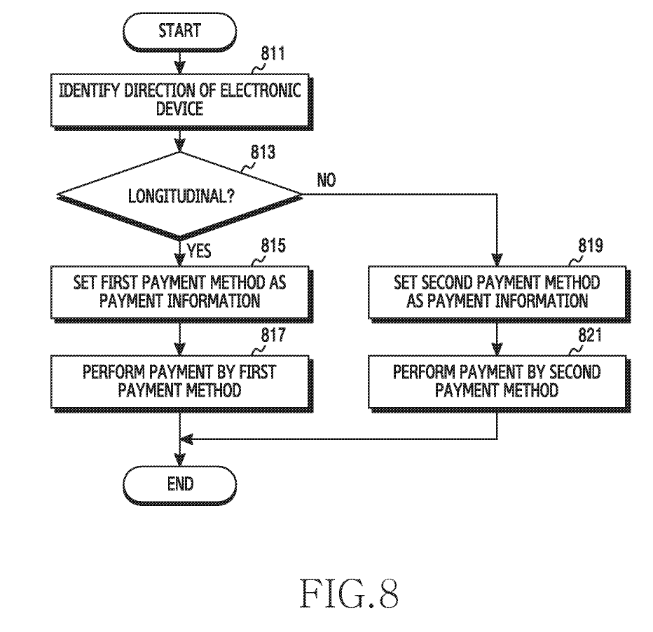

FIG. 8 is a flowchart illustrating a selection, depending on the direction of an electronic device, a payment method and performing payment according to various embodiments of the present disclosure. The operation as in FIG. 8 may be performed by the electronic device 400 in FIG. 4, and may be processed by, for example, the sensor module 440, the processor 410, or the communication module 420. The payment method may include a method such as payment by installment or lump-sum payment, coupons, or whether points are used.

Referring to FIG. 8, the electronic device may identify the direction of the electronic device in operation 811. For example, the sensor module 440 (illustrated in FIG. 4) placed inside the electronic device 400 may include a terrestrial magnetism sensor and may detect the direction of the electronic device 400. Further, the sensor module 440 may generate a signal related to the detected content and transmit the generated signal to the processor 410.

According to an embodiment, the electronic device 400 may determine, in operation 813, whether the direction of the electronic device is transverse or longitudinal. For example, the processor 410 may determine whether the direction of the electronic device 400 is currently transverse or longitudinal on the basis of a detection signal transmitted from the sensor module 440. The processor 410 may apply a threshold value in order to determine whether the direction of the electronic device 400 is transverse on the basis of the signal transmitted from the sensor module 440. For example, a threshold value may be set for dividing the direction of the electronic device 400 into the transverse direction and the longitudinal direction, and when the threshold value is satisfied, the direction may be deemed to be transverse. On the contrary, a threshold value may be set for dividing the direction of the electronic device 400 into the transverse direction and the longitudinal direction, and when the threshold value is not satisfied, the direction may be deemed to be longitudinal. Further, the reverse is possible.

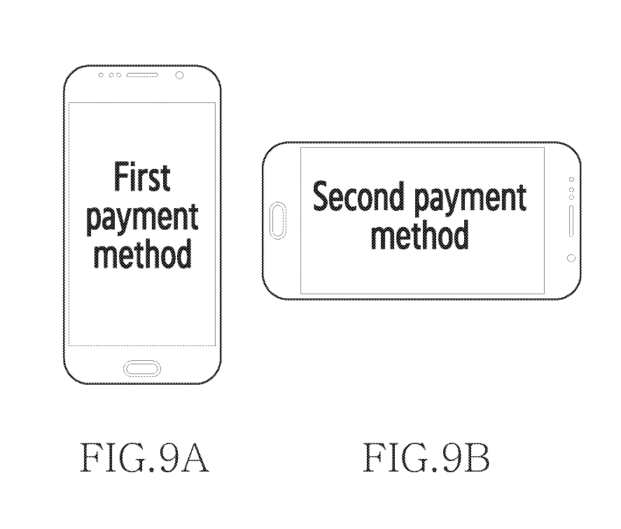

According to an embodiment, when the state of the electronic device 400 of FIG. 4 is determined to be longitudinal in operation 813, the electronic device 400 may set a first payment method as payment information in operation 815. For example, operation 815 may be performed in a situation as in FIG. 9A. Information on a payment method may he temporarily or non-temporarily stored in the memory 430 placed inside the electronic device 400. For example, when the state of the electronic device is determined to be longitudinal, the processor 410 may select, as a payment method, a first payment method temporarily or non-temporarily stored in the memory 430.

According to an embodiment, the electronic device 400 may perform payment by the first payment method in operation 817. For example, when the first payment method has been set as payment information in operation 815, the communication module 420 placed inside the electronic device 400 may wiredly or wirelessly transmit information on the first payment method to an external device. For example, the electronic device 400 may transmit, to an external payment device, information on payment corresponding to the first payment method. Accordingly, the electronic device 400 may perform payment by the first payment method.

According to an embodiment, when the state of the electronic device 400 is determined to be transverse in operation 813, the electronic device 400 may set a second payment method as payment information in operation 819. For example, operation 819 may be performed in a situation as in FIG. 9B hereinafter. Information on a payment method may be temporarily or non-temporarily stored in the memory 430 placed inside the electronic device 400. For example, when the state of the electronic device is determined to be transverse, the processor 410 may select, as a payment method, a second payment method temporarily or non-temporarily stored in the memory 430.

According to an embodiment, the electronic device 400 may perform payment by the second payment method in operation 821. For example, when the second payment method has been set as payment information in operation 819, the communication module 420 placed inside the electronic device 400 may wiredly or wirelessly transmit information on the second payment method to an external device. For example, the electronic device 400 may transmit, to an external payment device, information on payment corresponding to the second payment method. Accordingly, the electronic device 400 may perform payment by the second payment method.

FIGS. 9A and 9B illustrate changing a payment method depending on a change of the direction of an electronic device according to various embodiments of the present disclosure. FIGS. 9A and 9B illustrate examples of two states. However, according to an embodiment of the present disclosure, when three or more payment methods are considered, three or more states may be defined. The payment method may include a method such as payment of a price (payment by installment or lump-sum payment) or use of coupons or points.

Referring to FIGS. 9A and 9B, the electronic device 400 of FIG. 4 may be in a longitudinal state as in FIG. 7A or may be in a transverse state as in FIG. 7B. The direction may be detected using the sensor module 440 included in the electronic device 400. In examples of FIGS. 9A and 9B, the first payment method (e.g. lump-sum payment) may correspond to the longitudinal state of the electronic device 400 and the second payment method (e.g. payment by installment) may correspond to the transverse state of the electronic device 400. For example, when payment is performed while the electronic device 400 is in a longitudinal state, the electronic device 400 may be set such that the payment is performed by the first payment method. According to an embodiment, when payment is performed while the electronic device 400 is in a transverse state, the electronic device 400 may he set such that the payment is performed by the second payment method. According to an embodiment of the present disclosure, the second payment method may correspond to the longitudinal state of the electronic device 400 and the first payment method may correspond to the transverse state of the electronic device 400. Therefore, the processor 410 may select a payment method to be used for payment on the basis of the direction of the electronic device 400. For example, when the electronic device 400 is tagged to the payment device in a longitudinal direction, the first payment method, which has been set to be used when payment is performed while the electronic device 400 is in a longitudinal state, may be used as a payment method. :Further, when the electronic device 400 is tagged to the payment device in a transverse direction, the second payment method, which has been set to be used when payment is performed while the electronic device 400 is in a transverse state, may be used as a payment method,

According to an embodiment, as illustrated in FIGS. 9A and 9B, the electronic device 400 may display information indicating a selected payment method through a display unit. The display unit may include an output device (output unit), such as an image display, a speaker, or a motor (vibration notification). For example, the information indicating the selected payment method may be displayed in the form of a character or a figure. As another example, the information indicating the selected payment method may be displayed in the form of at least one of a character, a figure, a sound, a vibration, a graphic, and a color. According to an embodiment of the present disclosure, the information indicating the selected payment method may not be displayed.

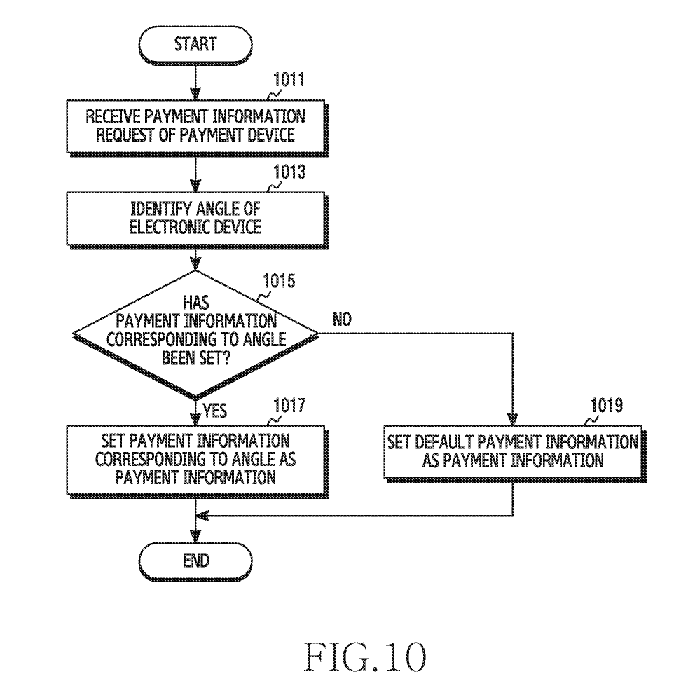

FIG. 10 is a flowchart illustrating setting payment information depending on the angle of an electronic device according to various embodiments of the present disclosure. The operation as in FIG. 10 may be performed by the electronic device 400 in FIG. 4, and may be processed by, for example, the sensor module 440, the processor 410, the memory 430, or the communication module 420. The communication module 420 may include the NFC module 288 for short range communication.

Referring to FIG. 10, the electronic device 400 may receive, in operation 1011, a payment information request made by the payment device 510 (illustrated in FIG. 5). The payment information may include information on a card to be used for payment and/or information on a payment method (e.g. lump-sum payment, payment by installment, installment period, or whether coupons or points are used). For example, the electronic device 400 may receive a payment information request from the payment device 510 through the NFC module 288.

According to an embodiment, as illustrated in FIG. 10, the electronic device 400 of FIG. 4 may identify the angle of the electronic device in operation 1013. The angle may include an angle which the electronic device 400 has with respect to a reference surface (e.g. ground and/or one surface of a payment device). The sensor module 440 placed inside the electronic device 400 may include a terrestrial magnetism sensor although it is not illustrated in drawings. The sensor module 440 may detect the angle of the electronic device 400. Further, the sensor module 440 may generate a signal related to the detected content and transmit the generated signal to the processor 410. The processor 410 may identify the angle of the electronic device on the basis of the received detection signal. The processor 410 may apply a threshold value in order to determine the angle of the electronic device 400 on the basis of the signal transmitted from the sensor module 440. For example, multiple threshold values may be set for dividing the angle of the electronic device 400, and the angle of the electronic device 400 may be determined on the basis of the multiple threshold values.

The electronic device 400 may determine, in operation 1015, whether payment information corresponding to the identified angle has been set. Payment information corresponding to each angle may have been temporarily or non-temporarily stored in the memory 430. Further, default payment information may have been temporarily or non-temporarily stored in the memory 430 of FIG. 4. The payment information may include payment means information (e.g. credit card information, membership card information, or the like) and/or information on a payment method (e.g. payment by installment, lump-sum payment). When payment information corresponding to an angle of the electronic device 400 which has been determined in operation 1013 has been set, the electronic device 400 may set the payment information corresponding to the angle as payment information in operation 1017. According to an embodiment, when the payment information corresponding to the angle has not been previously set, the electronic device 400 may set default payment information as payment information in operation 1019.

In the embodiment of FIG. 10, it may be assumed that there is a first electronic device including a payment function and a second electronic device connected thereto. According to an embodiment, when payment is performed by the first electronic device, information to be used for the payment may be selected on the basis of an angle of the first electronic device among two electronic devices. For example, where the first electronic device has a 90-degree angle with respect to a reference surface (e.g. ground or one surface of a payment device) when payment is performed using the first electronic device, the payment may be performed using payment information (e.g. first credit card information) included in the first electronic device. Further, where the first electronic device has a 0-degree angle with respect to a reference surface, the payment may be performed using payment information (e.g. second credit card information) included in the second electronic device.

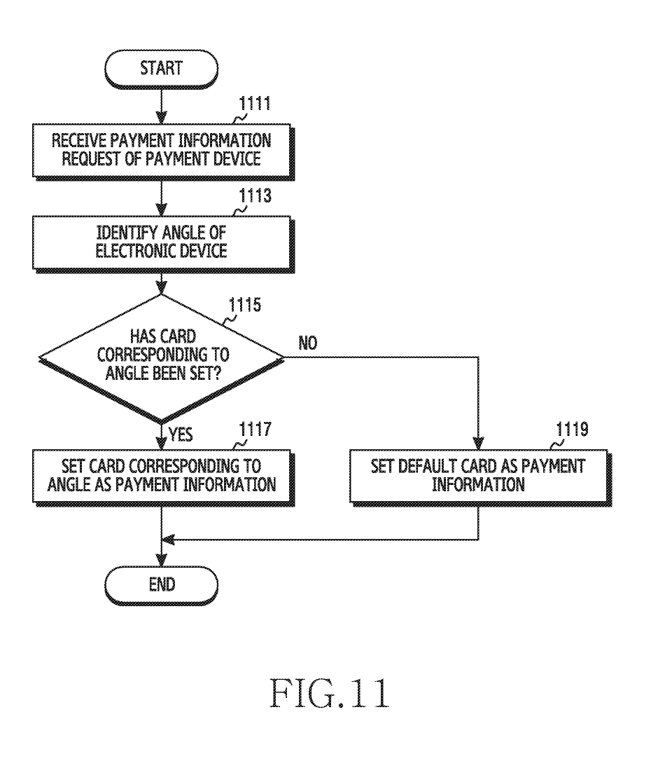

FIG. 11 is a flowchart illustrating selecting a payment means depending on the angle of an electronic device according to various embodiments of the present disclosure. The operation as in FIG. 10 may be performed by the electronic device 400 in FIG. 4, and may be processed by, for example, the sensor module 440, the processor 410, or the communication module 420. The communication module 420 may include the NFC module 288 for short range communication.

Referring to FIG. 11, according to various embodiments of the present disclosure, the electronic device 400 of FIG. 4 may receive, in operation 1111, a payment means information request made by a payment device. For example, the electronic device 400 may receive, through the NFC module 228, a payment means information request made by the payment device 510.

According to an embodiment, the electronic device 400 may identify an angle of the electronic device in operation 1113. The angle may include an angle which the electronic device 400 has with respect to a reference surface (e.g. ground and/or one surface of a payment device). The sensor module 440 placed inside the electronic device 400 may include at least one sensor (e.g. terrestrial magnetism sensor) although it is not illustrated in drawings. The sensor module 440 may detect the angle of the electronic device 400. Further, the sensor module 440 may generate a signal related to the detected content and transmit the generated signal to the processor 410. The processor 410 may identify an angle of the electronic device (e.g. an angle which the electronic device has with respect to a ground or an angle which the electronic device has with respect to one surface of a payment device) on the basis of the transmitted detection signal. The processor 410 may apply a threshold value in order to identify the angle of the electronic device 400 on the basis of the signal transmitted from the sensor module 440. For example, multiple threshold values may be set for dividing the angle of the electronic device 400, and an angle which the electronic device 400 has with respect to a reference surface may be determined on the basis of the multiple threshold values.

The electronic device 400 may determine, in operation 1115, whether a payment card corresponding to the identified angle has been set. Card information corresponding to each angle may have been temporarily or non-temporarily stored in the memory 430. Further, default card information may have been temporarily or non-temporarily stored in the memory 430. When a payment card corresponding to the angle of the electronic device 400 which has been determined in operation 1113 has been set, the processor 410, illustrated in FIG. 4, may set the payment card corresponding to the angle as a payment card in operation 1117. Further, when the payment card corresponding to the angle has not been previously set, the electronic device 400 may set a default card as payment information in operation 1119.

In the embodiment of FIG. 11, it may be assumed that in the case where there is a first electronic device including a payment function and a second electronic device connected thereto. According to an embodiment, when payment is performed by the first electronic device, a card to be used for the payment may be selected on the basis of an angle which the first electronic device among two electronic devices has with respect to a reference surface. For example, where the first electronic device has a 90-degree angle with respect to a reference surface when payment is performed using the first electronic device, the payment may be performed using first card information included in the first electronic device. Further, where the first electronic device has a 0-degree angle with respect to a reference surface, the payment may be performed using second card information included in the second electronic device.

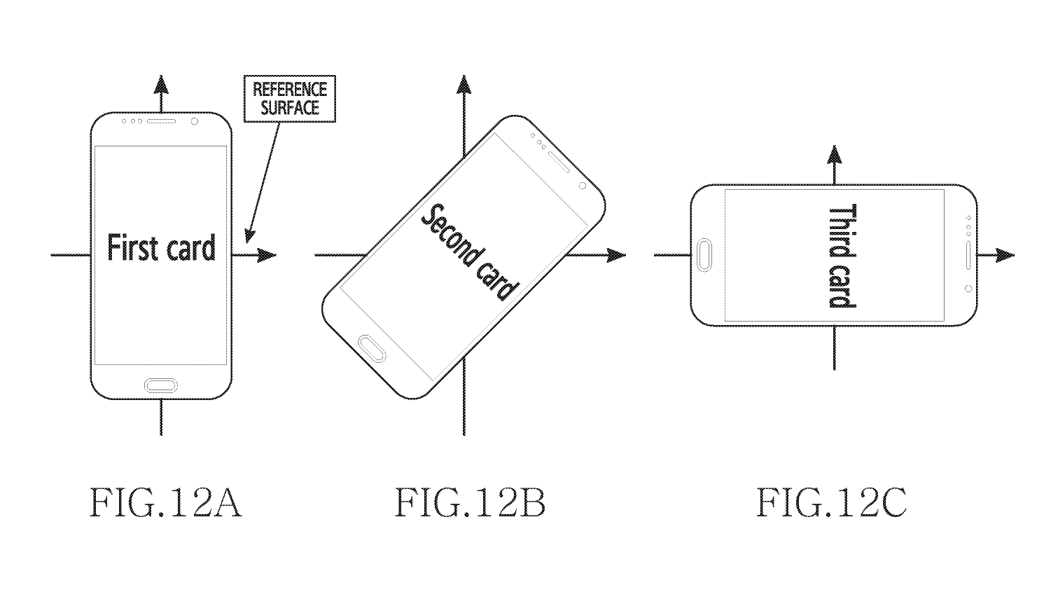

FIGS. 12A, 12B and 12C illustrate a method for changing a payment means depending on the angle of an electronic device according to various embodiments of the present disclosure, FIGS. 12A to 12C illustrate examples of three states. However, according to an embodiment of the present disclosure, when four or more payment means are considered, four or more states may be defined.

Referring to FIGS. 12A, 12B and 12C, the electronic device may be in a 90-degree angle state with respect to a reference surface as in FIG. 12A, may be in a 45-degree angle state with respect to a reference surface as in FIG. 12B, or may be in a 0-degree state with respect to a reference surface as in FIG. 12C. The reference surface may include a ground and/or one surface of a payment device. The angle with respect to the reference surface may be identified using the sensor module 440 included in the electronic device 400. In an embodiment of FIGS. 12A, 12B and 12C, a first card may correspond to the 90-degree angle state, a second card may correspond to the 45-degree angle state, and a third card may correspond to the 0-degree angle state. For example, when payment is performed while the electronic device 400 has a 90-degree angle with respect to a reference surface, the electronic device 400 may be set such that the payment is performed by the first card. Further, when payment is performed while the electronic device 400 has a 45-degree angle with respect to a reference surface, the electronic device 400 may be set such that the payment is performed by the second card. When payment is performed while the electronic device 400 has a 0-degree angle with respect to a reference surface, the electronic device 400 may be set such that the payment is performed by the third card. However, according to an embodiment of the present disclosure, corresponding relationships between the first, second, and third cards and the angles may be variously defined.

According to an embodiment, when the electronic device 400 of FIG. 4 is tagged to the payment device 510 of FIG. 5 in a 90-degree angle with respect to a reference surface, the first card, which has been set to be used when payment is performed while the electronic device 400 has a 90-degree angle, may be used as a payment means. Further, when the electronic device 400 is tagged to the payment device in a 45-degree angle with respect to a reference surface, the second card, which has been set to be used when payment is performed while the electronic device 400 has a 45-degree angle, may be used as a payment means. Further, when the electronic device 400 is tagged to the payment device in a 0-degree angle, the third card, which has been set to be used when payment is performed while the electronic device 400 has a 0-degree angle, may be used as a payment means.

According to an embodiment, as illustrated in FIGS. 12A, 12B and 12C, the electronic device 400 of FIG. 4 may display information indicating a selected card through a display unit. The display unit may include an output device (output unit), such as an image display, a speaker, or a motor (vibration notification). For example, the information indicating the selected card may he displayed in the form of a character or a figure. As another example, the information indicating the selected card may be displayed in the form of at least one of a character, a figure, a sound, a vibration, a graphic, and a color. According to an embodiment of the present disclosure, the information indicating the selected card may not be displayed.

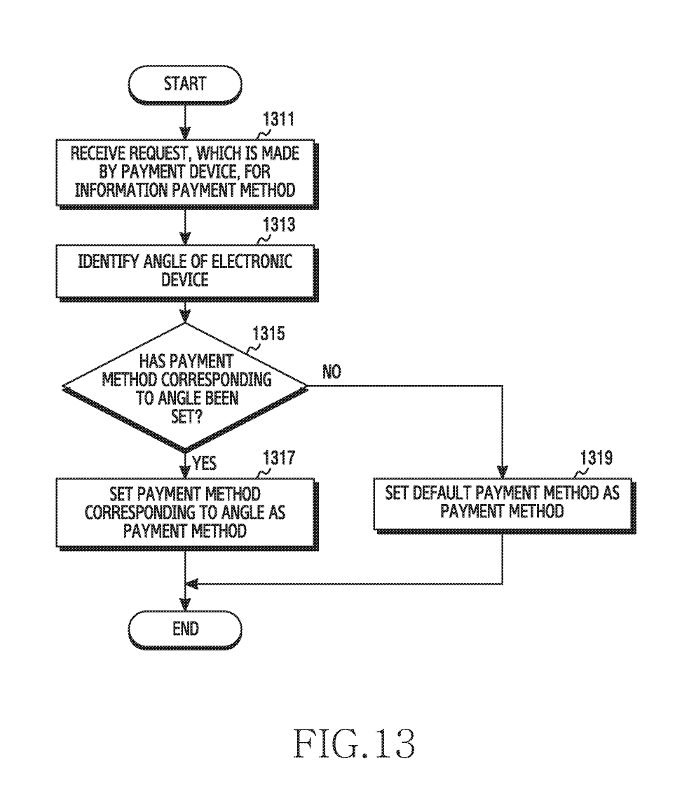

FIG. 13 is a flowchart illustrating a selection of a payment method depending on the angle of an electronic device according to various embodiments of the present disclosure. The payment method may include a method such as payment of a price (e.g. payment by installment or lump-sum payment) or use of coupons or points. The operation as in FIG. 13 may be performed by the electronic device 400 in FIG. 4, and may be processed by, for example, the sensor module 440, the processor 410, or the communication module 420. The communication module 420 may include the NTC module 288 for short range communication.

Referring to FIG. 13, the electronic device 400 of FIG. 4 may receive a request, which is made by the payment device 510, for information on a payment method in operation 1311. For example, the electronic device 400 may receive a request, which is made by the payment device 510 in FIG. 5, for information on a payment method through the NFC module 228 in FIG. 5.

According to an embodiment, the electronic device 400 may identify an angle of the electronic device in operation 1313. The angle may include an angle which the electronic device 400 has with respect to a reference surface (e.g. ground and/or one surface of a payment device). The sensor module 440 placed inside the electronic device 400 may include a terrestrial magnetism sensor although it is not illustrated in drawings. The sensor module 440 may detect the angle of the electronic device 400. Further, the sensor module 440 may generate a signal related to the detected content and transmit the generated signal to the processor 410. The processor 410 may identify the angle of the electronic device on the basis of the received detection signal. The processor 410 may apply a threshold value in order to identify the angle of the electronic device 400 on the basis of the signal transmitted from the sensor module 440. For example, multiple threshold values may be set for dividing the angle of the electronic device 400, and the angle of the electronic device 400 may he determined on the basis of the multiple threshold values.

The electronic device 400 may determine, in operation 1315, whether a payment method corresponding to the identified angle has been set. Information on a payment method corresponding to each angle may be temporarily or non-temporarily stored in the memory 430 previously. Further, information on a default payment method may be temporarily or non-temporarily stored in the memory 430. When information on a payment method corresponding to the angle of the electronic device 400 which has been determined in operation 1313 has been set, the processor 410 may set, in operation 1317, the information on the payment method corresponding to the angle as information on a payment method.

Further, when the information on the payment method corresponding to the angle has not been previously set, the electronic device 400 may set information on a default payment method as information on a payment method in operation 1319.

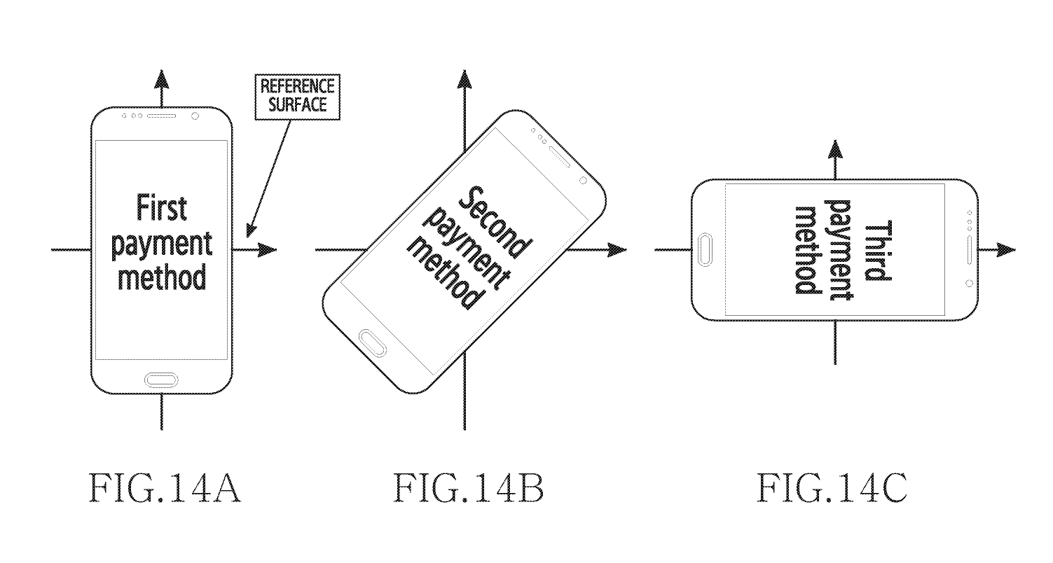

FIGS. 14A, 14B and 14C illustrate a method for changing a payment method depending on the angle of an electronic device according to various embodiments of the present disclosure. FIGS. 14A, 14B and 14C illustrate examples of three states. However, according to an embodiment of the present disclosure, when four or more payment methods are considered, four or more states may be defined.

Referring to FIGS. 14A, 14B and 14C, the electronic device 400 of FIG. 4 may be in a 90-degree angle state with respect to a reference surface as in FIG. 14A, may be in a 45-degree angle state with respect to a reference surface as in FIG. 14B, or may be in a 0-degree state with respect to a reference surface as in FIG. 14C. The angle may be detected using the sensor module 440 included in the electronic device 400. According to an embodiment of FIGS. 14A, 14B and 14C, a first payment method may correspond to the 90-degree angle state of the electronic device 400, a second payment method may correspond to the 45-degree angle state of the electronic device 400, and a third payment method may correspond to the 0-degree angle state of the electronic device 400. For example, when payment is performed while the electronic device 400 is at a 90-degree angle from a reference surface, the electronic device 400 may be set such that the payment is performed by the first payment method. When payment is performed while the electronic device 400 is at a 45-degree angle from the reference surface, the electronic device 400 may be set such that the payment is performed by the second payment method. Further, when payment is performed while the electronic device 400 is at a 0-degree angle from the reference surface, the electronic device 400 may be set such that the payment is performed by the third payment method. For example, when the electronic device 400 is tagged to the payment device at a 90-degree angle from the reference surface, the first payment method, which has been set to be used when payment is performed while the electronic device 400 is at a 90-degree angle, may be used as a payment method. Further, when the electronic device 400 of FIG. 4 is tagged to the payment device in a 45-degree angle, the second payment method, which has been set to be used when payment is performed while the electronic device 400 has a 45-degree angle, may be used as a payment method. Further, when the electronic device 400 is tagged to the payment device in a 0-degree angle, the third payment method, which has been set to be used when payment is performed while the electronic device 400 has a 0-degree angle, may be used as a payment method. According to an embodiment of the present disclosure, corresponding relationships between the first, second, and third payment methods and the angles may be variously defined.

According to an embodiment, as illustrated in FIGS. 14A, 148, and 14C, the electronic device 400 may display information indicating a selected payment method through a display unit. The display unit may include an output device (output unit), such as an image display, a speaker, or a motor (vibration notification) For example, the information indicating the selected payment method may be displayed in the form of a character or a figure. As another example, the information indicating the selected payment method may be displayed in the form of at least one of a character, a figure, a sound, a vibration, a graphic, and a color. However, according to an embodiment of the present disclosure, the information indicating the selected payment method may not be displayed.

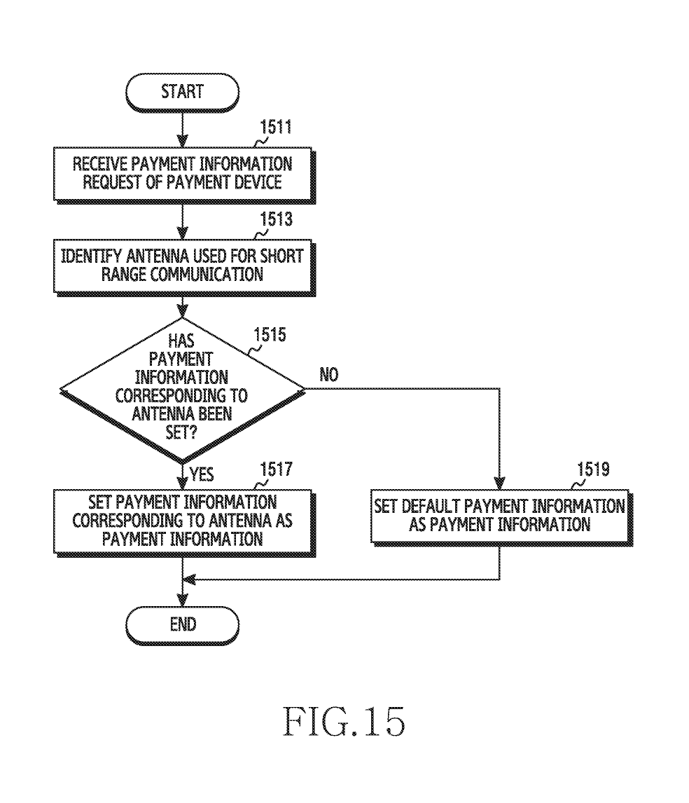

FIG. 15 is a flowchart illustrating selecting payment information by using a plurality of antennas or a plurality of short range communication modules in an electronic device according to various embodiments of the present disclosure. The electronic device 400 of FIG. 4 may include a plurality of antennas and may communicate with an external device by using the plurality of antennas, individually or together. The plurality of antennas may be placed in at least some areas (e.g. one side) of the electronic device. Payment information may be set and stored, in advance, with respect to the antennas placed in the at least some areas. The embodiment of FIG. 15 relates to a method for performing payment through communication with the external device by the electronic device 400. In the embodiment, it is assumed that at least one among the plurality of antennas is used.

Referring to FIG. 15, the electronic device 400 may receive, in operation 1511, a payment information request made by a payment device. Payment information may include information on a card to be used for payment and/or information on a payment method (e.g. lump-sum payment, payment by installment, installment period, or whether coupons or points are used). The payment information request may be received through one of the plurality of antennas included in the electronic device 400.

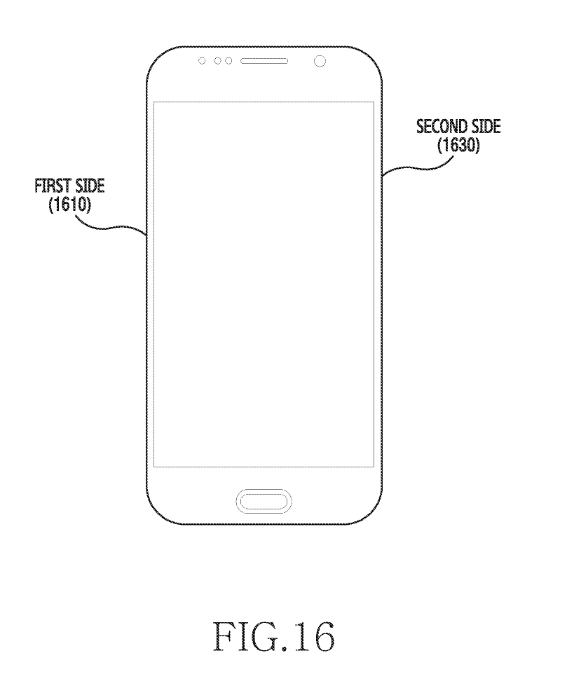

According to an embodiment, in operation 1513, the electronic device 400 may identify an antenna, which is used for short range communication for payment, among the plurality of antennas included inside the electronic device. For example, the processor 410 of FIG. 4 may identify an antenna, which is used for short range communication for payment, among the plurality of antennas. For example, the electronic device 400 may determine an antenna, which is used for short range communication for payment, on the basis of the intensity of a received signal measured by each of the plurality of antennas. For example, referring to FIG. 16, when a first side 1610 of the electronic device 400 is proximate to the payment device for performing payment, a first antenna disposed at the first side 1610 of the electronic device 400 may be used so that short range communication for payment can be performed. Further, when a second side 1630 of the electronic device 400 is proximate to the payment device for performing payment, a second antenna disposed at the second side 1630 may be used so that short range communication for payment can be performed. The first and second sides are merely provided as examples and therefore the electronic device 400 may include more sides. Further, the electronic device 400 may include at least one antenna in some areas of the electronic device.

FIG. 16 illustrates a method for selecting payment information by using a plurality of antennas according to various embodiments of the present disclosure.

After identifying an antenna used for short range communication for payment, the electronic device 400 of FIG. 4 may determine, in operation 1515 (as illustrated in FIG. 15), whether payment information corresponding to the antenna has been set. For example, when communication for payment is performed through a first antenna placed at the first side of the electronic device 400, a first card (or a first payment method) may be set as a payment means. Further, when communication for payment is performed through a second antenna placed at the second side of the electronic device 400, a second card (or a second payment method) may be set as a payment means.

When the payment information corresponding to the antenna used for short range communication for payment has been set in operation 1515, the electronic device 400 may set the payment information corresponding to the antenna as payment information in operation 1517. Therefore, payment may be performed through a payment means corresponding to an antenna used for short range communication.

Further, when the payment information corresponding to the antenna used for short range communication for payment has not been set in operation 1515, the electronic device 400 may set default payment information as payment information in operation 1519.

According to various embodiments of the present disclosure, a payment means (e.g. the kind of a card) or a payment method (e.g. lump-sum payment, payment by installment, installment period) may be dynamically changed on the basis of the state (for example, an angle, a direction, or a used antenna) of the electronic device 400 in FIG. 4. The determining of the payment means and payment method on the basis of the state may be performed at various time points. Hereinafter, the present disclosure will describe various embodiments related to a time point when a payment means and a payment method are determined.

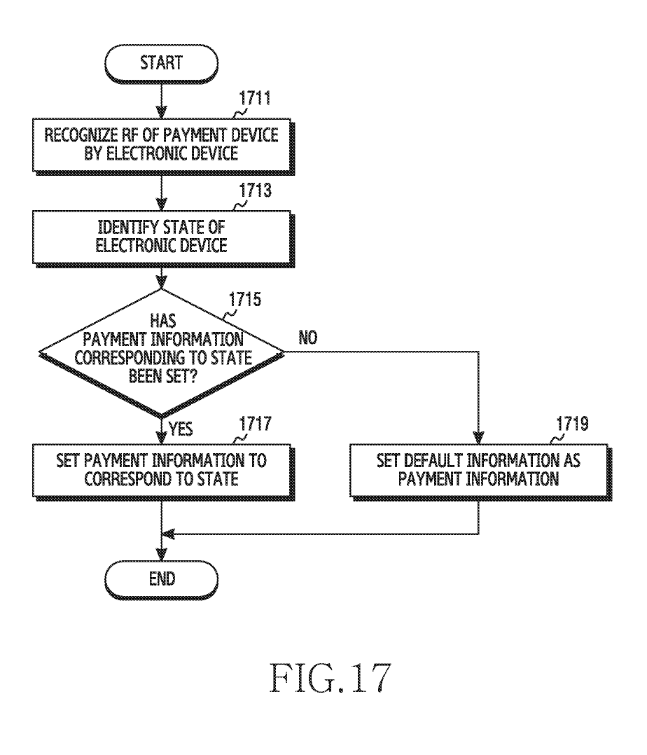

FIG. 17 is a flowchart illustrating controlling the time to select payment information on the basis of the intensity of a signal of an external device in an electronic device according to various embodiments of the present disclosure. The operation as in FIG. 17 may be performed by the electronic device 400 in FIG. 4, and may be processed by, for example, the sensor module 440, the processor 410, or the communication module 420. The communication module 420 may include the NFC module 288 for short range communication.

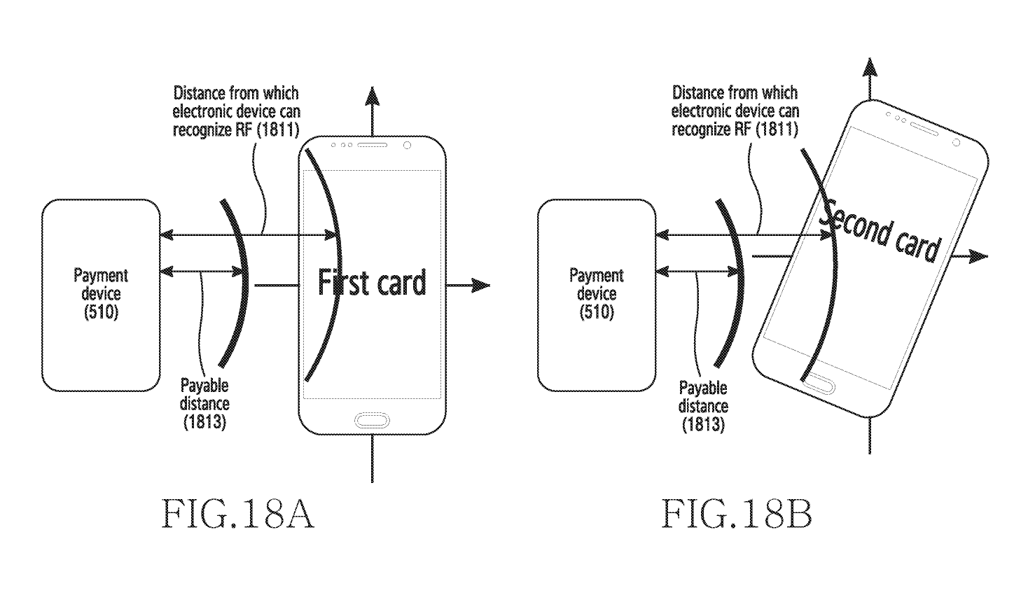

Referring to FIG. 17, in operation 1711, the electronic device 400 may recognize, through the communication module 420, a radio frequency (RF) signal of an external device, for example, the payment device 510 of FIG. 5. Referring to FIGS. 18A and 18B, the electronic device 400 approaches within a distance 1811 from which the RF of the payment device 510 can be recognized, the electronic device 400 may recognize the RE of the payment device 510.

The electronic device 400 of FIG. 4 may identify a state of the electronic device in operation 1713, e.g., via its communication module 420. The state of the electronic device may include at least one of a direction (e.g. transverse direction or longitudinal direction), an angle (e.g. 90 degrees, 45 degrees, or 0 degree, relative to a reference surface), and an antenna that is used. According to an embodiment, the electronic device 400 may apply a threshold value in order to identify the state of the electronic device 400 on the basis of a signal transmitted from the sensor module 440. For example, multiple threshold values may be set for dividing the state of the electronic device 400, and the state of the electronic device 400 may be determined on the basis of the multiple threshold values.

The electronic device 400 of FIG. 4 may determine, in operation 1715, whether payment information (e.g. a payment means or a payment method) corresponding to the identified state has been set. Payment information corresponding to each state may have been temporarily or non-temporarily stored in the memory 430 previously. Further, default payment information may have been temporarily or non-temporarily stored in the memory 430. When the payment information corresponding to the state of the electronic device 400, determined in operation 1713, has been set, the electronic device 400 may set the payment information corresponding to the state as payment information in operation 1717. Further, when the payment information corresponding to the state has not been previously set, the electronic device 400 may set default payment information as payment information in operation 1719.

In the embodiment of FIG. 17, it may be assumed that in the case where there is a first electronic device including a payment function and a second electronic device connected thereto. According to an embodiment, when payment is performed by the first electronic device, payment information to he used for the payment may be selected on the basis of a state of the first electronic device among two electronic devices. For example, where the first electronic device has a 90-degree angle with respect to the payment device when payment is performed using the first electronic device, the payment may be performed using first payment information included in the first electronic device. Further, when the first electronic device has a 0-degree angle with respect to the payment device, the payment may be performed using second payment information included in the second electronic device.

FIGS. 18A and 18B illustrate changing payment information on the basis of the intensity of a signal of an external device in an electronic device according to various embodiments of the present disclosure. FIGS. 18A and 18B illustrate examples of two states. However, according to an embodiment of the present disclosure, when three or more payment means/methods are considered, three or more states may be defined.

Referring to FIGS. 18A and 18B, the electronic device may have a 90-degree angle with respect to a reference surface as in FIG. 18A or may have a 45-degree angle with respect to a reference surface as in FIG. 18B. The state of the electronic device 400 in FIG. 4 may be detected using the sensor module 440 included in the electronic device 400. According to an embodiment of FIGS. 18A and 18B, a first card (or a first payment method) may be set to correspond to the 90-degree state and a second card (or a second payment method) may be set to correspond to the 45-degree state. For example, when payment is performed while the electronic device 400 is in the 90-degree state, the electronic device 400 may be set such that the payment is performed by the first card (or the first payment method). Further, when payment is performed while the electronic device 400 is in the 45-degree state, the electronic device 400 may be set such that the payment is performed by the second card (or the second payment method). Further, according to an embodiment of the present disclosure, the second card may correspond to the 90-degree state and the first card may correspond to the 45-degree state. Therefore, the processor 410 may select a card to be used for payment on the basis of the state of the electronic device 400.

According to an embodiment, as illustrated in FIGS. 18A and 18B, the electronic device 400 may approach within a distance 1811 from which a signal of the payment device 510 can be recognized. At this time, the electronic device 400 may identify the state (e.g. angle) of the electronic device 400 and select payment means information which has been set to correspond to the identified state. For example, approaching within the distance 1811, from which a signal of the payment device 510 can be recognized, may be a condition for changing payment information. FIG. 18A illustrates that the electronic device 400 has approached the distance 1811, from which an RE of the payment device 510 can be recognized, while the electronic device 400 has a 90-degree angle with respect to a reference surface (e.g. one surface of a payment device or a ground). FIG. 18B illustrates that the electronic device 400 has approached the distance 1811, from which an RF of the payment device 510 can be recognized, while the electronic device 400 has a 45-degree angle with respect to a reference surface.

According to an embodiment, when the electronic device 400 of FIG. 4 is within a payable distance 1813, the payment may be performed depending on payment information corresponding to the state of the electronic device 400. For example, as in FIG. 18A, when the electronic device is within the payable distance 1813 while the electronic device is at a 90-degree angle with respect to a reference surface (e.g. one surface of a payment device or a ground), the first card (or the first payment method) may be used as a payment means. Further, as in FIG. 18B, when the electronic device is within the payable distance 1813 while the electronic device is at a 45-degree angle with respect to a reference surface one surface of a payment device or a ground), the second card (or the second payment method) may be used as a payment means.

According to an embodiment, as illustrated in FIGS. 18A and 18B, the electronic device 400 may display information indicating a selected card (or payment method) through a display unit. The display unit may include an output device (output unit), such as an image display, a speaker, or a motor (vibration notification). For example, the information indicating the selected card (or payment method) may be displayed in the form of a character or a figure. As another example, the information indicating the selected card may be displayed in the form of at least one of a character, a figure, a sound, a vibration, a graphic, and a color. However, according to an embodiment of the present disclosure, the information indicating the selected card (or payment method) may not be displayed.

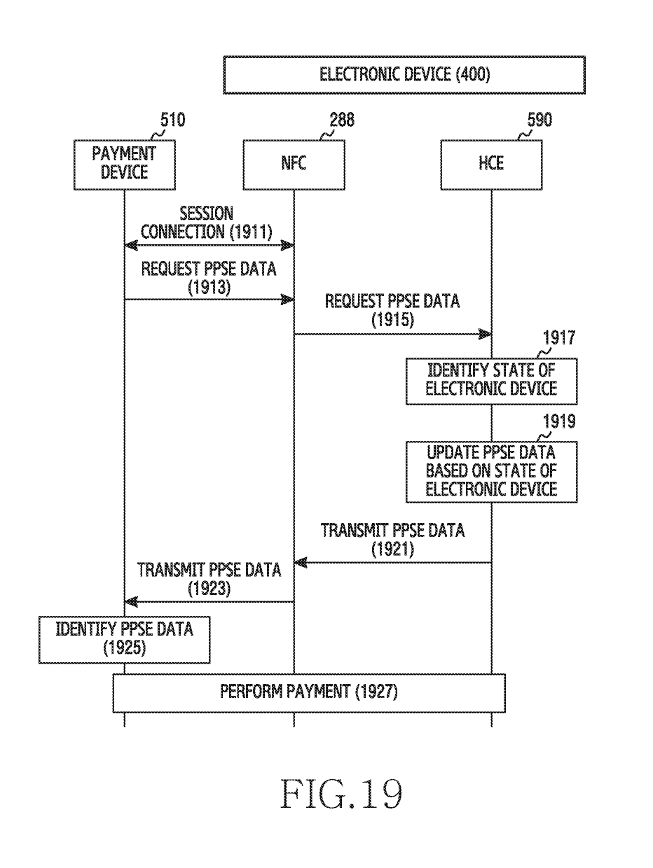

FIG. 19 is a flowchart illustrating controlling of the selection of payment information at the time of payment in an electronic device according to various embodiments of the present disclosure.

Referring to FIG. 19, the electronic device 400 may perform a session connection to the payment device 510 in operation 1911. The session connection between the electronic device 400 and the payment device 510 may be performed through a communication module (e.g. NFC module 288). For example, the NFC module 288 of the electronic device 400 may transmit/receive at least one message for a session connection to the payment device 510.

After the session connection is performed, the payment device 510 may send a request for proximity payment system environment (PPSE) data to the electronic device 400 in operation 1913. The PPSE data may include association identifier (AID) information on data of a particular card to be used at the time of payment. In order to change a card used for payment, an AID of the card to be used for payment should he registered in the PPSE.

Host card emulation (HCE) 590 that is embedded in the electronic device 400 may receive a PPSE data request from the NFC module 288 in operation 1915. Thereafter, the HCE 590 may identify a state of the electronic device in operation 1917. The state of the electronic device may include at least one of the direction of the electronic device, the angle of the electronic device, and an antenna used when the electronic device communicates with the payment device 510.

Referring to FIG. 19, in operation 1919, the HCE 590 may update PPSE data based on the identified state of the electronic device. For example, an AID value of a card, which is determined according to the state (e.g. direction, angle, or antenna) of the electronic device, may be updated in the PPSE. For example, in the case of an embedded security element (eSE), a particular AID value may be updated in PPSE data which is preset in the eSE through Samsung contactless register service (SCRS). In the case of the HCE 590, a corresponding AID value may he updated in a PPSE stored inside the HCE 590.

The HCE 590 may transmit PPSE data having the updated AID value to the NFC module 288 in operation 1921. The NFC module 288 may transmit the PPSE data including the updated AID value to the payment device 510 in operation 1923. Therefore, the payment device 510 may identify the received PPSE data in operation 1925 and may process payment between the payment device 510 and the electronic device 400 through the PPSE data in operation 1927.

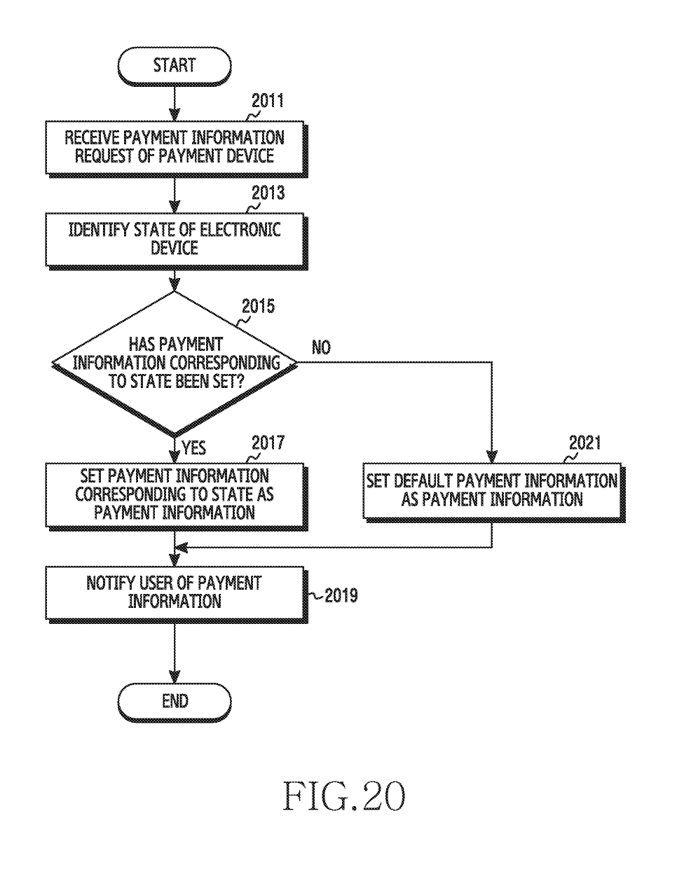

FIG. 20 is a flowchart illustrating notifying of a change of payment information in an electronic device according to various embodiments of the present disclosure. The operation as in FIG. 20 may be performed by the electronic device 400, and may be processed by, for example, the sensor module 440, the processor 410, or the communication module 420. The communication module 420 may include the NFC module 288 for short range communication.

Referring to FIG. 20, the electronic device 400 (illustrated in FIGS. 4 and 5) may receive, in operation 2011, a payment information request made by a payment device. For example, the electronic device 400 may receive, through the NFC module 228, a payment means information request made by the payment device.

According to an embodiment, the electronic device 400 may identify a state of the electronic device in operation 2013. For example, the state of the electronic device 400 may include a direction, an angle, a used antenna, or the like. The angle may include an angle which the electronic device 400 has with respect to a reference surface (e.g. ground and/or one surface of a payment device). The electronic device 400 may determine the state thereof through the sensor module 440. The electronic device 400 may apply a threshold value in order to identify the state of the electronic device 400 on the basis of a signal transmitted from the sensor module 440.

The electronic device 400 may determine, in operation 2015, whether payment information corresponding to the identified state has been set. The payment information may include information on a payment means (e.g. the kind of a card) and/or information on a payment method (e.g. lump-sum payment, payment by installment, installment period, or whether coupons or points are used).

When the payment information corresponding to the state of the electronic device 400, determined in operation 2013, has been set, the electronic device 400 may set the payment information corresponding to the state as payment information in operation 2017. Further, when the payment information corresponding to the state has not been previously set, the electronic device 400 may set default payment information as payment information in operation 2021.

Referring to FIG. 20, the electronic device 400 may receive user notification of payment information in operation 2019. For example, the electronic device 400 may receive the user notification of payment information from the NFC module 288. Therefore, the electronic device 400 may notify a user of payment completion through an interface thereof. For example, the electronic device 400 may display a notification window notifying of the payment completion or output a notification sound/vibration.

In the embodiment of FIG. 20, it may be assumed that in the case where there is a first electronic device including a payment function and a second electronic device connected thereto. According to an embodiment, when payment is performed by the first electronic device, a card to be used for the payment may be selected on the basis of an angle which the first electronic device among two electronic devices has with respect to a reference surface. For example, where the first electronic device has a 90-degree angle with respect to a reference surface when payment is performed using the first electronic device, the payment may be performed using first card information included in the first electronic device. Further, where the first electronic device has a 0-degree angle with respect to a reference surface, the payment may be performed using second card information included in the second electronic device.

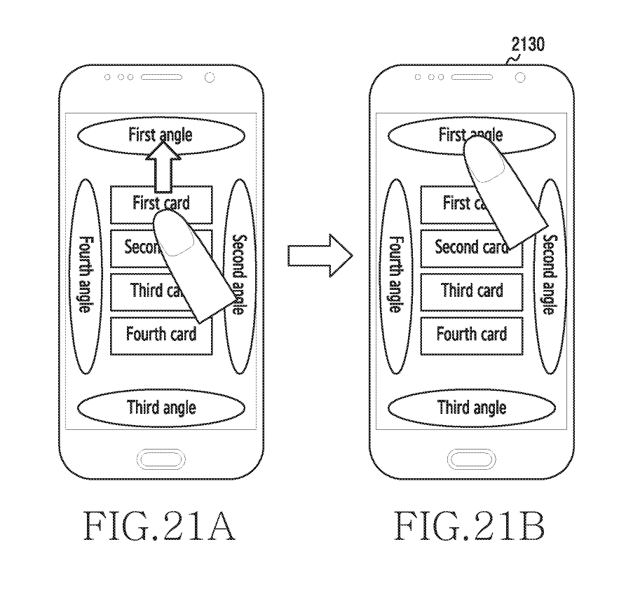

FIGS. 21A and 21B illustrate an interface for setting a payment means in an electronic device according to various embodiments of the present disclosure.

Referring to FIGS. 21A and 21B, a user may display a list of usable cards in the middle of a screen 2130 of the electronic device 400 of FIGS. 4 and 5 and may display an area, which a selected card can be dragged to and dropped into, at a corner part of the screen. For example, referring to FIGS. 21A and 21B, the user may select a first card from among usable cards displayed on the screen and then drag and drop the first card to/into a first area (e.g. a card area to be used when the electronic device is in a longitudinal state), which is at least a part of a screen of the electronic device. Further, the user may select a second card from among usable cards displayed on the screen and then drag and drop the second card to/into a second area (e.g. a card area to be used when the electronic device is in a transverse state), which is at least a part of a screen of the electronic device. After this operation, when the state of the electronic device is changed from the longitudinal state to the transverse state, a card to be used for payment may be changed from the first card to the second card. Although not specified in FIGS. 21A and 21B, a list of usable payment methods may be displayed in the middle of the screen of the electronic device 400, instead of the list of usable cards. Further, there can be an embodiment in which the user drags and drops a selected payment method to/into the corner part, thereby changing a payment method according to the state of the electronic device.

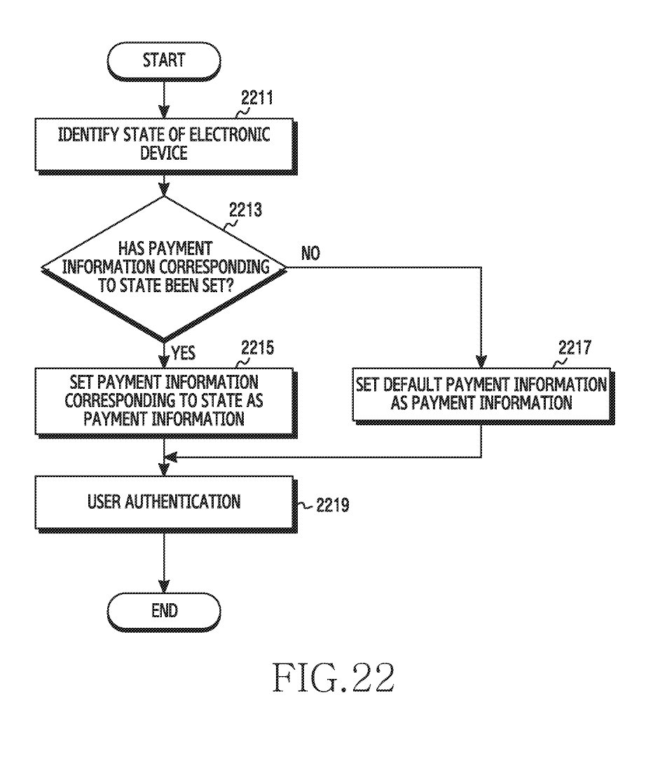

FIG. 22 is a flowchart illustrating a payment information change and user authentication according to various embodiments of the present disclosure. The operation as in FIG. 22 may be performed by the electronic device 400 in FIG. 4, and may be processed by, for example, the sensor module 440, the processor 410, or the communication module 420. The communication module 420 may include the NFC module 288 (illustrated in FIG. 2) for short range communication.

Referring to FIG. 22, the electronic device 400 may identify a state of the electronic device 400 in operation 2211. For example, the state of the electronic device 400 may include an angle of the electronic device. The angle may include an angle which the electronic device 400 has with respect to or relative to a reference surface (e.g. ground and/or one surface of a payment device). The sensor module 440 (illustrated in FIG. 4) that is placed inside the electronic device 400 may include a terrestrial magnetism sensor although it is not illustrated in drawings. The sensor module 440 may detect the angle of the electronic device 400. Further, the sensor module 440 may generate a signal related to the detected content and transmit the generated signal to the processor 410. The processor 410 may identify the relative angle of the electronic device 400 on the basis of the received detection signal. The processor 410 may apply a threshold value in order to identify the angle of the electronic device 400 on the basis of the signal transmitted from the sensor module 440. For example, multiple threshold values may be set for dividing the angle of the electronic device 400, and the angle of the electronic device 400 may be determined on the basis of the multiple threshold values.

The electronic device 400 may determine, in operation 2213, whether payment information corresponding to the identified state has been set. The payment information may include card information and/or information on a payment method. Payment information corresponding to each angle may be temporarily or non-temporarily stored in the memory 430. Further, default payment information may be temporarily or non-temporarily stored in the memory 430. When payment information corresponding to the state of the electronic device 400, determined in operation 2013, has been set, the processor 410 may set the payment information corresponding to the state as payment information in operation 2215. Further, when the payment information corresponding to the state has not been previously set, the electronic device 400 may set default payment information as payment information in operation 2217.

Referring to FIG. 22, when the payment information is set according to the state of the electronic device 400, the electronic device 400 may receive user authentication related to the selected payment information in operation 2219. The user may recognize the payment information through a display unit of the electronic device 400. The display unit may include an output device (output unit), such as an image display, a speaker, or a motor (vibration notification). For example, the payment information may be displayed in the form of a character or a figure. As another example, the payment information may be displayed in the form of at least one of a character, a figure, a sound, a vibration, a graphic, and a color.

According to an embodiment, the electronic device 400 may fix the payment information after the user authentication. For example, even when the state of the electronic device 400 is changed after the user authentication, payment may be performed through payment information designated at the time of the authentication.

According to an embodiment, the user authentication operation 2219 may he performed prior to operation 2211 of identifying the state of the electronic device. In this case, the user authentication operation may become authentication for starting an operation of selecting payment information according to the state of the electronic device 400. Further, when payment information is set in operation 2215 of setting the payment information corresponding to the state as the payment information to operation 2217 of setting default payment information as the payment information, payment may be performed by the set payment information even when the state of the electronic device 400 is changed.

According to an embodiment, receiving a payment information request of the payment device is performed prior to operation 2211 of identifying the state of the electronic device 400, and the user authentication operation may be performed prior to the receiving of the payment information request. In this case, the user authentication operation may also become authentication for starting an operation of selecting payment information according to the state of the electronic device 400.

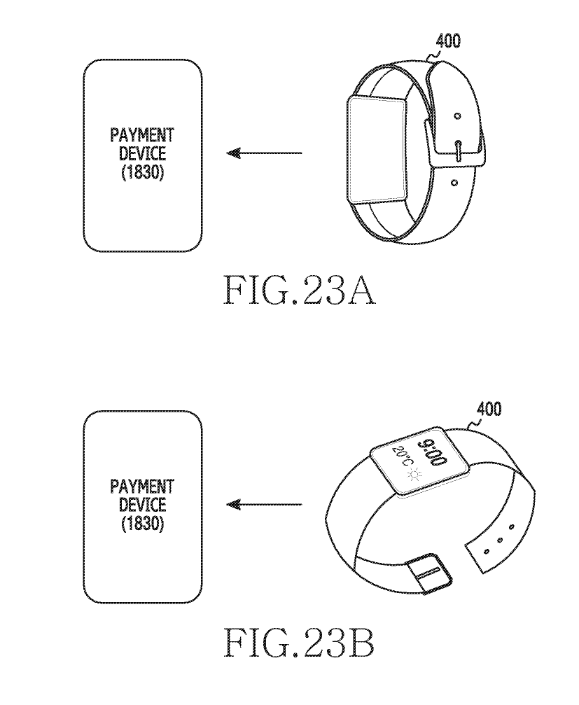

FIGS. 23A and 23B illustrate a payment method when a plurality of electronic devices is connected according to various embodiments of the present disclosure. It may be assumed that both a first electronic device and a second electronic device connected thereto have an embedded security element (eSE). In this case, an electronic device (e.g. the first electronic device, the second electronic device) including a card to be used for payment may be selected on the basis of the location where an electronic device performing payment is tagged, and the payment may be performed using the card included in the selected electronic device.

For example, an electronic device can he combined with a wearable device, and the two devices may include payment information. Referring to FIGS. 23A and 23B, an electronic device 400 in the form of a watch type wearable device may include NFC in a body thereof and may also include NFC in a watchband thereof. When payment is performed through a tag using an NFC antenna included in the body as in FIG. 23A, the payment may be performed using payment information stored in the wearable device. Further, when payment is performed through a tag using an NFC antenna included in the watchband as in FIG. 23B, the payment may be performed using payment information stored in the connected electronic device or payment device 1830. There can be various embodiments which are similar or dissimilar to this arrangement.

According to various embodiments of the present disclosure, in addition to which antenna is tagged, the state (e.g. angle, direction, used antenna) of the tagged device may be combined, and thereby more various options on payment may be controlled. For example, a payment means (e.g. the kind of a card) may be determined through the watchband and the body and a payment method (e.g. lump-sum payment, payment by installment, installment period) may be determined according to a direction at the time of tag.

According to various embodiments of the present disclosure, an operation method of an electronic device may include: selecting information on payment on the basis of a state of the electronic device; and transmitting the information to an external device, wherein the state may include at least one among an orientation of the electronic device, an angle with respect to a reference axis, and an antenna used to communicate with the external device.

The antenna may include one of at least one antenna included in the electronic device and at least one antenna included in another (electronic) device which is connected to the electronic device.

The information on the payment may include a card used for payment and/or a payment scheme.

The operation method or method of operation of the electronic device may further include fixing the information on the payment through authentication.

The operation method of the electronic device may further include outputting feedback which notifies of a change in the information on the payment, wherein the feedback may include at least one of a sound, a vibration, and a screen display.

The information on the payment may be selected when the state of the electronic device is changed, when the intensity of a signal received from the external device exceeds a threshold value, or when a payment information request signal is received from the external device.

The operation method of the electronic device may further include: displaying a screen for inputting a corresponding relationship between multiple states and multiple pieces of information on the payment; and setting the corresponding relationship according to a user input.

The operation method of the electronic device may further include receiving a signal from another electronic device, wherein, in the selecting of the information on the payment, the information on the payment may be selected on the basis of the signal and wherein the signal may include information on the state of the another electronic device.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific IC (ASIC) chip, a field-programmable gate arrays (FPGA), and a programmable-logic device for performing operations which are known or are to be developed hereinafter.

According to various embodiments, at least some of the devices (for example, modules or functions thereof) or the method (for example, operations) according to the present disclosure may be implemented by a command stored in a computer-readable storage medium in a program module form. The instruction, when executed by a processor (e.g., the processor 120), may cause the one or more processors to execute the function corresponding to the instruction. The computer-readable recoding media may be, for example, the memory 130.

The computer readable recoding medium may include a hard disk, a floppy disk, magnetic media (e.g., a magnetic tape), optical media (e.g., a compact disc ROM (CD-ROM) and a DVD), magneto-optical media (e.g., a floptical disk), a hardware device (e.g., a ROM, a RAM, a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

Any of the modules or program modules according to various embodiments of the present disclosure may include at least one of the above described elements, exclude some of the elements, or further include other additional elements. The operations performed by the modules, program module, or other elements according to various embodiments of the present disclosure may be executed in a sequential, parallel, repetitive, or heuristic manner. Further, some operations may be executed according to another order or may be omitted, or other operations may be added.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for operating an electronic device, the method comprising:
selecting information on payment based on a state of an electronic device; and
transmitting the selected information to an external device,
wherein the state of the electronic device comprises at least one of an orientation of the electronic device, an angle with respect to a reference axis, and one or more antennas used to communicate with the external device.

2. The method of claim 1, wherein the one or more antennas comprises at least one antenna included in the electronic device and at least one antenna included in another electronic device which is connected to the electronic device.

3. The method of claim 1, wherein the information on the payment comprises at least one of a card used for the payment and a payment scheme.

4. The method of claim 1, further comprising fixing the information on the payment through authentication.

5. The method of claim 1, further comprising outputting feedback which notifies of a change in the information on the payment,
wherein the feedback comprises at least one of a sound, a vibration, and a screen display.

6. The method of claim 1, wherein the information on the payment is selected when the state of the electronic device is changed, when the intensity of a signal received from the external device exceeds a threshold value, or when a payment information request signal is received from the external device.

7. The method of claim 1, further comprising:
displaying a screen for inputting a corresponding relationship between multiple states and multiple pieces of information on the payment; and
setting the corresponding relationship according to a user input.

8. The method of claim 1, further comprising receiving a signal from another electronic device,
wherein, in the selecting of the information of the payment, the information on the payment is selected based on the signal, and
wherein the signal comprises information on the state of the other electronic device.

9. An electronic device comprising:
a housing;
a processor configured to be arranged inside the housing and to select information on payment based on a state of the electronic device; and
a communication module configured to transmit the information to an external device,
wherein the state of the electronic device comprises at least one of an orientation of the electronic device, an angle with respect to a reference axis, and an antenna used to communicate with the external device.

10. The electronic device of claim 9, wherein the antenna is one of at least one antenna included in the electronic device and at least one antenna included in another device which is connected to the electronic device.

11. The electronic device of claim 9, wherein the information on the payment comprises at least one of a card used for the payment and a payment scheme.

12. The electronic device of claim 9, wherein the processor is further configured to fix the information on the payment through authentication.

13. The electronic device of claim 9, further comprising an output device configured to output feedback which notifies of a change in the information on the payment,
wherein the feedback comprises at least one of a sound, a vibration, and a screen display.

14. The electronic device of claim 9, wherein the information on the payment is selected when the state of the electronic device is changed, when the intensity of a signal received from the external device exceeds a threshold value, or when a payment information request signal is received from the external device.

15. The electronic device of claim 9, further comprising a display configured to display a screen for inputting a corresponding relationship between multiple states and multiple pieces of information on the payment.

16. The electronic device of claim 9,
wherein the communication module is further configured to receive a signal from another electronic device and the processor selects the information on the payment based on the signal, and
wherein the signal comprises the information on the state of the other electronic device.

17. An electronic device comprising:
a housing;
a communication module configured to be disposed inside the housing and to wirelessly transmit information on at least one card to an external device;
a sensor configured to sense an orientation of the electronic device and generate a first signal;
a processor configured to be electrically connected to the wireless communication module and the sensor; and
a memory configured to he electrically connected to the processor and at least temporarily store first card information and second card information,
wherein the memory stores instructions which instruct the processor to:
receive the first signal;
select one of the first card information and the second card information, at least partially based on the first signal; and
wirelessly transmit the selected card information to the external device.

18. The electronic device of claim 17, wherein the first card information or the second card information comprises at least one of credit card information, a token associated with the credit card, membership information, coupon information, cash card information, user identification card information, and traffic card information.

19. The electronic device of claim 17, wherein the instructions comprise an instruction which instructs the processor to select card information when the orientation of the electronic device is changed, when the intensity of a signal received from the external device exceeds a threshold value, or when a payment information request signal is received from the external device.

20. The electronic device of claim 17, further comprising a display configured to:
display a screen for inputting a corresponding relationship between multiple orientations of the electronic device and multiple pieces of card information, and
set the corresponding relationship according to a user input.
